(19) United States
(12) Patent Application Publication
(10) Pub. No.: US 2009/0008161 A1
(43) Pub. Date: Jan. 8, 2009

(54) Capacitive sensor array and gesture recognition

(76) Inventors: Christopher W. Jones, Bothell, WA (US); Ryan D. Seguine, Seattle, WA (US)

Correspondence Address: CYPRESS/BLAKELY;Blakely Sokoloff Taylor & Zafman LLP, 1279 Oakmead Parkway, SUNNYVALE, CA, 94085-4040, US

(21) Appl. No.: 11/978,075

(22) Filed: Oct. 25, 2007

Related U.S. Application Data
(60) Provisional application No. 60/947,950, filed on Jul. 4, 2007.

(51) Int. Cl. G06F 3/044

(52) U.S. Cl. 178/18.06

(57) ABSTRACT

Apparatus and methods for determining a deflection of a moveable conductive plate that is moved over a capacitive sensing device. The method may include moving the moveable conductive plate over sensor elements of the capacitive sensing device, and determining the deflection of the moveable conductive plate. In determining the deflection, a deflection magnitude and a deflection direction may be determined by calculating a vector of x- and y-directions or a vector of a radius and an angle.

### RELATED APPLICATIONS

This application claims the benefit of U.S. Provisional Application No. 60/947,950, filed Jul. 4, 2007.

### TECHNICAL FIELD

This invention relates to the field of user interface devices and, in particular, to touch-sensor devices.

### BACKGROUND

Computing devices, such as notebook computers, personal digital assistants (PDAs), kiosks, and mobile handsets, have user interface devices, which are also known as human interface devices (HID). One user interface device that has become more common is a touch-sensor pad (also commonly referred to as a touchpad). A basic notebook computer touch-sensor pad emulates the function of a personal computer (PC) mouse. A touch-sensor pad is typically embedded into a PC notebook for built-in portability. A touch-sensor pad replicates mouse x/y movement by using two defined axes which contain a collection of sensor elements that detect the position of a conductive object, such as a finger. Mouse right/left button clicks can be replicated by two mechanical buttons, located in the vicinity of the touchpad, or by tapping commands on the touch-sensor pad itself. The touch-sensor pad provides a user interface device for performing such functions as positioning a pointer, or selecting an item on a display. These touch-sensor pads may include multi-dimensional sensor arrays for detecting movement in multiple axes. The sensor array may include a one-dimensional sensor array, detecting movement in one axis. The sensor array may also be two dimensional, detecting movements in two axes.

Capacitance sensing has been implemented in a wide variety of user interfaces of electronic devices to replace mechanical buttons in the electronic devices. Examples include touchpads on notebook computers, touchscreens, and slider controls used for menu navigation in cellular phones, personal music players, and other hand held electronic devices. Capacitance sensing has many advantages over conventional cursor control devices, mechanical switches, and rotary encoders. A principal such advantage is the lack of moving parts, which allows capacitance sensing to provide great improvements in reliability, since there are no moving parts to wear out.

One type of conventional capacitance sensing device is a slider that operates by way of capacitance sensing utilizing capacitive sensors. The capacitance detected by a capacitive sensor changes as a function of the proximity of a conductive object to the sensor. The conductive object can be, for example, a stylus or a user's finger. In an electronic device, a change in capacitance detected by each sensor in the X and Y dimensions of the sensor array due to the proximity or movement of a conductive object can be measured by a variety of methods. The touch-sensor devices may include single sensor elements or elements arranged in multiple dimensions for detecting a presence of the conductive object on the touch-sensor device. Regardless of the method, usually an electrical signal representative of the capacitance detected by each capacitive sensor is processed by a processing device, which in turn produces electrical or optical signals representative of the position of the conductive object in relation to the capacitance sensing device, such as in relation to the touch-sensor pad in the X and Y dimensions.

FIG. 1A illustrates a conventional linear touch-sensor slider. The linear touch-sensor slider 110 includes a surface area 111 on which a conductive object may be used to control a setting on a device, such as volume or brightness. Alternatively, the linear touch-sensor slider 110 may be used for scrolling functions. The construct of touch-sensor slider 110 may be similar to that of a touch-sensor pad. Touch-sensor slider 110 may include a sensor array capable of detection in only one dimension (referred to herein as one-dimensional sensor array). The slider structure may include one or more sensor elements that may be conductive traces. By positioning or manipulating a conductive object in contact or in proximity to a particular portion of the slider structure, the capacitance between each conductive trace and ground varies and can be detected. The capacitance variation may be sent as a signal on the conductive trace to a processing device. It should also be noted that the sensing may be performed in a differential fashion, obviating the need for a ground reference. For example, by detecting the relative capacitance of each sensor element, the position and/or motion (if any) of the external conductive object can be determined. It can be determined which sensor element has detected the presence of the conductive object, and it can also be determined the motion and/or the position of the conductive object over multiple sensor elements.

Radial sensing is conventionally done using a radial slider that is used in detecting position information on the outside of a ring, or on sensor elements disposed in a circular manner, as illustrated in FIG. 1B. The radial sensor array 150 of FIG. 1B includes multiple sensor elements 151 disposed in a circular pattern. Radial sensing may also be done using a touchpad with radius and degree output from the touchpad. Radial sensing using a touchpad, however, uses more complex position algorithms, such as to perform conversion from X and Y dimensions to a radius and angle. Also, touchpads may have small sensor activation areas, resulting in a decrease in sensitivity. One conventional electronic device that includes a radial sensor array having a ring or other circular pattern of sensor elements, determines the position of the conductive object on the radial sensor array and then uses the determined position to make decisions based on the direction of movement of the conductive object on the radial sensor array. The circular sensor array pattern, which may be useful in some applications, may be limited in a two-dimensional space application, because the complete circular pattern may be too large. Moreover, repeated revolutions around a radial sensor to perform a continuous scrolling operation, even when based on speed of the conductive object, can be ineffective and cumbersome to the user. For example, to scroll through a large menu, the user must move his finger around the radial sensor array in at least one rotation in order to continue the scrolling operation. In addition to being larger in size and requiring repetition, these conventional designs only deal with radial motion, and not a design that deals with radial, planar, and linear motions with various sensor patterns.

### BRIEF DESCRIPTION OF THE DRAWINGS

The present invention is illustrated by way of example, and not by way of limitation, in the figures of the accompanying drawings.

FIG. 1A illustrates a conventional linear touch-sensor slider.

FIG. 1B illustrates a conventional radial slider.

FIG. 2 illustrates a block diagram of one embodiment of an electronic system having a processing device for detecting a presence of a conductive object.

FIG. 3A illustrates a varying capacitance sensor element.

FIG. 3B illustrates one embodiment of a sensing device coupled to a processing device.

FIG. 3C illustrates one embodiment of a relaxation oscillator for measuring capacitance on a sensor element.

FIG. 3D illustrates a schematic of one embodiment of a circuit including a sigma-delta modulator and a digital filter for measuring capacitance on a sensor element.

FIG. 4 illustrates a block diagram of one embodiment of an electronic device including a processing device that includes a capacitance sensor for measuring the capacitance on a sensor array.

FIG. 5A illustrates two linear slider arrays to detect radial scrolling gestures according to one embodiment of the present invention.

FIG. 5B illustrates the two linear slider arrays of FIG. 5A configured to detect left and right scrolling gestures according to one embodiment of the present invention.

FIG. 5C illustrates the two linear sliders of FIG. 5A configured to detect up- and down-scrolling gestures.

FIG. 6A illustrates a linear sensor array to detect various scrolling gestures according to one embodiment of the present invention.

FIG. 6B illustrates a linear sensor array to detect up- and down-scrolling gestures according to one embodiment of the invention.

FIG. 7A illustrates a radial sensor array to detect radial-scrolling gestures and left- and right-scrolling gestures according to one embodiment of the present invention.

FIG. 7B illustrates a radial sensor array to detect radial-scrolling gestures and left- and right-scrolling gestures according to another embodiment of the present invention.

FIG. 7C illustrates a radial sensor array to detect radial-scrolling gestures and up- and down-scrolling gestures according to another embodiment of the present invention.

FIG. 8 illustrates a figure-eight radial slider to detect radial scrolling gestures and left- and right-scrolling gestures according to one embodiment of the present invention.

FIG. 9 illustrates a graph of the sensitivity of a single sensor element of a sensory array.

FIG. 10 illustrates one embodiment of a selection circuit coupled to an analog bus for measuring capacitance on sensor elements.

FIG. 11 illustrates a flow chart of one embodiment of a method for detecting various scrolling gestures on a sensor array.

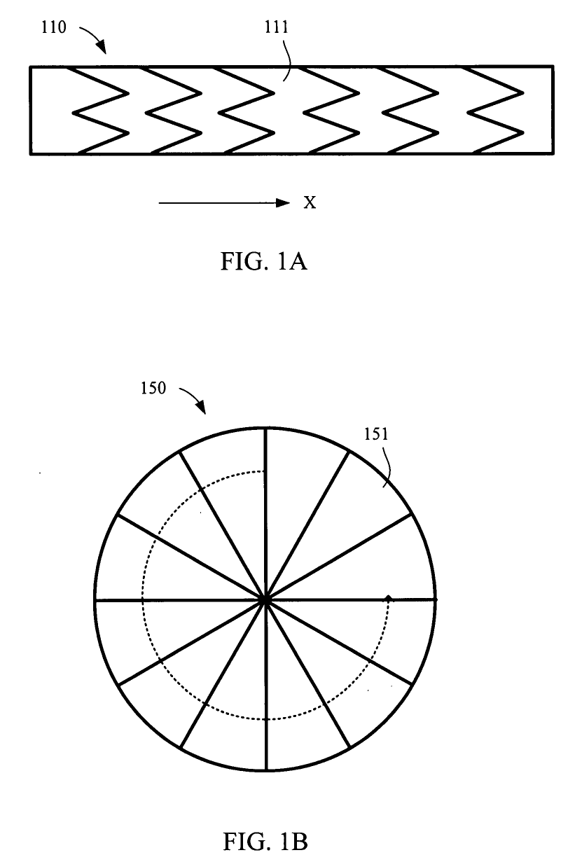

### DETAILED DESCRIPTION

Described herein are apparatuses and methods for detecting a scrolling gesture on the sensor array when the conductive object is moved initially in a first direction from a first position and subsequently in a second direction without the conductive object being removed from the sensor array. The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

Embodiments of a method and apparatus are described to detect a scrolling gesture on the sensor array when the conductive object is moved initially in a first direction from a first position and subsequently in a second direction without the conductive object being removed from the sensor array. In one embodiment using a single linear slider array, a finger is placed in one location on the single linear slider array. If the finger then moves to the right, a right scroll is detected and sent to the host. If the finger stops before the edge of the single linear slider array or if the finger is released from the single linear slider array, scrolling is stopped. If the finger continues to move after first starting in the right direction, right scrolling is continued. It is also possible to put regions in the slider on the left and right sides. If the finger is placed on the single linear slider array and the slide action stops inside the region, scrolling is continued until release.

The embodiments described herein include a capacitive sensing interface that uses a combination of hardware and firmware elements to determine the position of a finger on a sensor array and make decisions in a graphical user interface based on the position and movement of the finger along the array. The embodiments described herein may use an array of capacitive sensors set up as two separate arrays, or as one continuous sensor array. When used as a continuous array, standard radial slider or high-function linear slider operation may be employed. When used as two separate arrays, each array may have a different function associated with it. In other embodiments, the array of capacitance sensors may be a radial sensor array that is configured to detect both radial-scrolling gestures as well as continuous scrolling gestures without the conductive object being moved in at least one rotation of the radial sensor array. It should be noted that a radial slider is not the only construction, but in other embodiments, a pair of linear slider arrays arranged vertically may be used to achieve the same functionality.

In one embodiment, sensor position is used to make decisions using finger position based on the graphical user interface (GUI) settings or parameters that are passed to the sensing controller. The embodiments described above are some examples of this. Using the two sensors together allows a radial slider interface. Using the two arrays as separate sliders allows easier scrolling in either direction using a more simple interaction than a circular movement on a conventional radial sensor array.

In one embodiment, the method includes detecting a presence of a conductive object on a sensor array at a first position, and detecting a scrolling gesture on the sensor array when the conductive object is moved initially in a first direction from the first position and subsequently in a second direction. Also, the method may also include detecting an end of the scrolling gesture when the conductive object is released from the sensor array. Upon detecting the end of the scrolling gesture, the scrolling operation is stopped.

In detecting the scrolling gesture, an initial motion of the conductive object is detected in the first direction from the first position, and then subsequent motion of the conductive object is detected without the conductive object being released from the sensor array. The subsequent motion may include right or left motions, or alternatively, up or down motions of the conductive object on the sensor array.

In one embodiment, the speeds of the initial motion and the subsequent motion are detected, and the scrolling speed of the scrolling gesture is controlled based on the speeds. The scrolling gesture may be one of various types of gestures, such as scroll-right, scroll-left, scroll-up, scroll-down, scroll-right-and-stop, scroll-left-and-stop, scroll-up-and-stop, scroll-down-and-stop, continuous scroll-right, continuous scroll-left, continuous scroll-up, continuous scroll-left, or the like, as described in more detail below.

In one embodiment, a slider, using a capacitive sensor array, may be used in a computing device (e.g., desktop, laptop, palmtop, etc.) keyboard that may replace a mouse, touch sensor pad, force-sensing joystick, mechanical buttons, or the like. Alternatively, the sensor arrays described herein may be used in a computing device in addition to one or more of a mouse, touch sensor pad, force-sensing joystick, touch-sensor buttons, mechanical buttons, or the like.

The embodiments described herein use the sensor elements that are coupled to a processing device to detect various scrolling gestures, as described herein. The sensor elements may be part of a single linear array, two adjacent linear arrays, a radial sensor array, a figure-eight-shaped sensor array, or the like. In one embodiment, a processing device is coupled to receive signals from a first linear sensor array. The processing device is configured to detect a continuous scrolling gesture on the first linear sensor array without the conductive object being released from and reapplied to the first linear sensor array to continue the continuous scrolling gesture. In another embodiment, the processing device is coupled to receive signals from a second linear sensor array. The processing device is configured to detect a second continuous scrolling gesture on the second linear sensor array without the conductive object being released from and reapplied to the second linear sensor array to continue the second continuous scrolling gesture. In another embodiment, the processing device is configured to detect a scroll-right gesture on the first linear sensor array and a scroll-left gesture on the second linear sensor array. Similarly, the processing device may detect a scroll-up gesture on the first linear sensor array and a scroll-down gesture on the second linear sensor array.

In another embodiment, the processing device is configured to detect a radial scrolling gesture when the conductive object is detected as moving from the first linear sensor array to the second linear sensor array.

In another embodiment, the processing device is configured to receive signals from a radial sensor array. The processing device is configured to detect a continuous scrolling gesture on the radial sensor array without the conductive object being moved in at least one rotation of the radial sensor array. In one embodiment, the processing device detects a scroll-right gesture on a first portion of the radial sensor array and a scroll-left gesture on a second portion of the radial sensor array. Similarly, the processing device may detect a scroll-up gesture on the first portion and a scroll-down gesture on the second portion of the radial sensor array.

The embodiments described herein may provide an advantage over conventional capacitance sensing systems by allowing a smaller form-factor using the linear slider(s), instead of radial sliders, to detect scrolling gestures. Another advantage may be that multiple output configurations may be used based on the information passed to the capacitive sensing controller. For example, the sensor array may be configured to operate as either a combined array or multiple separate arrays based on information passed from the host. In one mode, the two separate arrays may be configured to detect a scrolling operation for directional movements. In the second mode, the two separate arrays may be used as a single linear slider for normal slider operations.

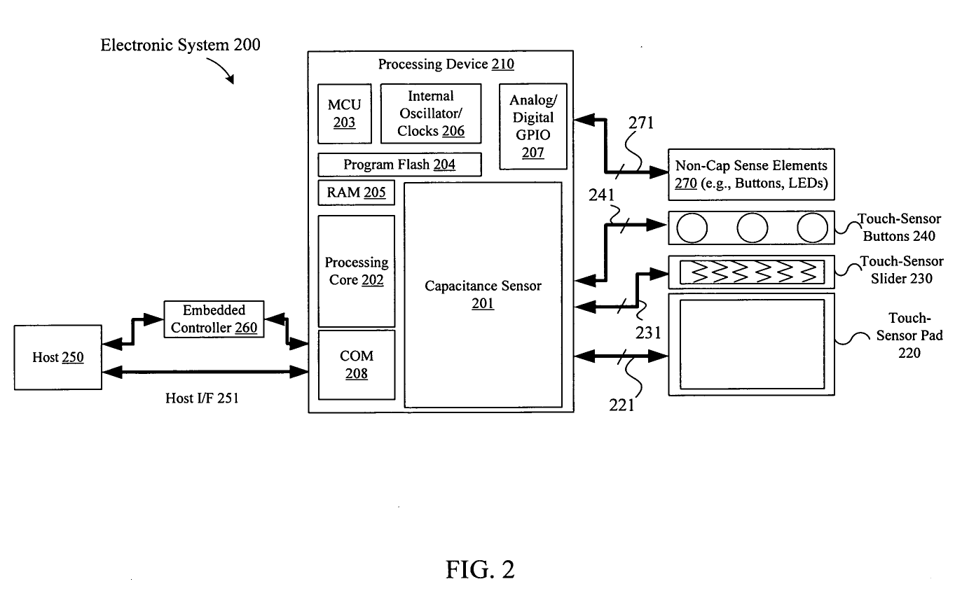

FIG. 2 illustrates a block diagram of one embodiment of an electronic system having a processing device for detecting a presence of a conductive object. Electronic system 200 includes processing device 210, touch-sensor pad 220, touch-sensor slider 230, touch-sensor buttons 240, host processor 250, embedded controller 260, and non-capacitance sensor elements 270. The processing device 210 may include analog and/or digital general purpose input/output (“GPIO”) ports 207. GPIO ports 207 may be programmable. GPIO ports 207 may be coupled to a Programmable Interconnect and Logic (“PIL”), which acts as an interconnect between GPIO ports 207 and a digital block array of the processing device 210 (not illustrated). The digital block array may be configured to implement a variety of digital logic circuits (e.g., DAC, digital filters, digital control systems) using, in one embodiment, configurable user modules (“UMs”). The digital block array may be coupled to a system bus (not illustrated). Processing device 210 may also include memory, such as random access memory (RAM) 205 and program flash 204. RAM 205 may be static RAM (SRAM) or the like, and program flash 204 may be a non-volatile storage, or the like, which may be used to store firmware (e.g., control algorithms executable by processing core 202 to implement operations described herein). Processing device 210 may also include a memory controller unit (MCU) 203 coupled to memory and the processing core 202.

The processing device 210 may also include an analog block array (not illustrated). The analog block array is also coupled to the system bus. Analog block array also may be configured to implement a variety of analog circuits (e.g., ADC, analog filters) using, in one embodiment, configurable UMs. The analog block array may also be coupled to the GPIO 207.

As illustrated, capacitance sensor 201 may be integrated into processing device 210. Capacitance sensor 201 may include analog I/O for coupling to an external component, such as touch-sensor pad 220, touch-sensor slider 230, touch-sensor buttons 240, and/or other devices. Capacitance sensor 201 and processing device 210 are described in more detail below.

It should also be noted that the embodiments described herein may be implemented in other sensing technologies than capacitive sensing, such as resistive, optical imaging, surface acoustical wave (SAW), infrared, dispersive signal, strain gauge technologies, or the like. Similarly, the operations described herein are not limited to notebook pointer operations, but can include other operations, such as lighting control (dimmer), temperature or environmental control, volume control, graphic equalizer control, speed control, or other control operations requiring gradual or discrete adjustments. It should also be noted that these embodiments of capacitive sensing implementations may be used in conjunction with non-capacitive sensing elements, including but not limited to pick buttons, sliders (ex. display brightness and contrast), scroll-wheels, multi-media control (ex. volume, track advance, etc.) handwriting recognition and numeric keypad operation.

In one embodiment, the electronic system 200 includes a touch-sensor pad 220 coupled to the processing device 210 via bus 221. Touch-sensor pad 220 may include a two-dimension sensor array. The two-dimension sensor array includes multiple sensor elements, organized as rows and columns. In another embodiment, the electronic system 200 includes a touch-sensor slider 230 coupled to the processing device 210 via bus 231. Touch-sensor slider 230 may include a single-dimension sensor array. The single-dimension sensor array includes multiple sensor elements, organized as rows, or alternatively, as columns. In another embodiment, the electronic system 200 includes touch-sensor buttons 240 coupled to the processing device 210 via bus 241. Touch-sensor button 240 may include a single-dimension or multi-dimension sensor array. The single- or multi-dimension sensor array includes multiple sensor elements. For a touch-sensor button, the sensor elements may be coupled together to detect a presence of a conductive object over the entire surface of the sensing device. Alternatively, the touch-sensor button 240 has a single sensor element to detect the presence of the conductive object. In one embodiment, the touch-sensor button 240 may be a capacitance sensor element. Capacitance sensor elements may be used as non-contact sensors. These sensor elements, when protected by an insulating layer, offer resistance to severe environments.

The electronic system 200 may include any combination of one or more of the touch-sensor pad 220, touch-sensor slider 230, and touch-sensor button 240. In another embodiment, the electronic system 200 may also include non-capacitance sensor elements 270 coupled to the processing device 210 via bus 271. The non-capacitance sensor elements 270 may include buttons, light emitting diodes (LEDs), and other user interface devices, such as a mouse, a keyboard, a display, or other functional keys that do not require capacitance sensing. In one embodiment, buses 271, 241, 231, and 221 may be a single bus. Alternatively, these buses may be configured into any combination of one or more separate buses.

The processing device 210 may also provide value-added functionality such as keyboard control integration, LEDs, battery charger, and general purpose I/O, as illustrated as non-capacitance sensor elements 270. Non-capacitance sensor elements 270 are coupled to the GPIO 207.

Processing device 210 may include internal oscillator/clocks 206 and communication block 208. The oscillator/clocks block 206 provides clock signals to one or more of the components of processing device 210. Communication block 208 may be used to communicate with an external component, such as a host processor 250, via host interface (I/F) 251. Alternatively, the processing device 210 may also be coupled to embedded controller 260 to communicate with the external components, such as host 250. Interfacing to the host 250 can be through various methods. In one exemplary embodiment, interfacing with the host 250 may be done using a standard PS/2 interface to connect to an embedded controller 260, which in turn sends data to the host 250 via a low pin count (LPC) interface. In some instances, it may be beneficial for the processing device 210 to do both sensing device and keyboard control operations, thereby freeing up the embedded controller 260 for other housekeeping functions. In another exemplary embodiment, interfacing may be done using a universal serial bus (USB) interface directly coupled to the host 250 via host interface 251. Alternatively, the processing device 210 may communicate to external components, such as the host 250 using industry standard interfaces, such as USB, PS/2, inter-integrated circuit (I2C) bus, system packet interfaces (SPI), or the like. The host 250 and/or embedded controller 260 may be coupled to the processing device 210 with a ribbon or flex cable from an assembly, which houses the sensing device and processing device.

In one embodiment, the processing device 210 is configured to communicate with the embedded controller 260 or the host 250 to send and/or receive data. The data may be a command or alternatively a signal. In an exemplary embodiment, the electronic system 200 may operate in both standard-mouse compatible and enhanced modes. The standard-mouse compatible mode utilizes the HID class drivers already built into the Operating System (OS) software of host 250. These drivers enable the processing device 210 and sensing device to operate as a standard pointer control user interface device, such as a two-button PS/2 mouse. The enhanced mode may enable additional features such as scrolling or disabling the sensing device, such as when a mouse is plugged into the notebook. Alternatively, the processing device 210 may be configured to communicate with the embedded controller 260 or the host 250, using non-OS drivers, such as dedicated touch-sensor pad drivers, or other drivers known by those of ordinary skill in the art.

In one embodiment, the processing device 210 may operate to communicate data (e.g., commands or signals) using hardware, software, and/or firmware, and the data may be communicated directly to the processing device of the host 250, such as a host processor, or alternatively, may be communicated to the host 250 via drivers of the host 250, such as OS drivers, or other non-OS drivers. It should also be noted that the host 250 may communicate directly with the processing device 210 via host interface 251.

In one embodiment, the data sent to the host 250 from the processing device 210 includes click, double-click, movement of the pointer, scroll-up, scroll-down, scroll-left, scroll-right, step back, step forward, or the like. In another embodiment, the data sent to the host 250 includes the position or location of the conductive object on the sensing device. Alternatively, other user interface device commands may be communicated to the host 250 from the processing device 210. For example, these commands may be based on gestures occurring on the sensing device that are recognized by the processing device, such as tap, push, hop, drag, and zigzag gestures. Alternatively, other commands may be recognized. Similarly, signals may be sent that indicate the recognition of these operations.

Processing device 210 may reside on a common carrier substrate such as, for example, an integrated circuit (IC) die substrate, a multi-chip module substrate, or the like. Alternatively, the components of processing device 210 may be one or more separate integrated circuits and/or discrete components. In one exemplary embodiment, processing device 210 may be the Programmable System on a Chip (PSoC®) processing device, developed by Cypress Semiconductor Corporation, San Jose, Calif. Alternatively, processing device 210 may be one or more other processing devices known by those of ordinary skill in the art, such as a microprocessor or central processing unit, a controller, special-purpose processor, digital signal processor (DSP), an application specific integrated circuit (ASIC), a field programmable gate array (FPGA), or the like. In an alternative embodiment, for example, the processing device may be a network processor having multiple processors including a core unit and multiple microengines. Additionally, the processing device may include any combination of general-purpose processing device(s) and special-purpose processing device(s).

It should also be noted that the embodiments described herein are not limited to having a configuration of a processing device coupled to a host, but may include a system that measures the capacitance on the sensing device and sends the raw data to a host computer where it is analyzed by an application. In effect the processing that is done by processing device 210 may also be done in the host. In another embodiment, the processing device 210 is the host.

In one embodiment, the method and apparatus described herein may be implemented in a fully self-contained sensing device, which outputs fully processed x/y movement and gesture data signals or data commands to a host. In another embodiment, the method and apparatus may be implemented in a sensing device, which outputs x/y movement data and also finger presence data to a host, and where the host processes the received data to detect gestures. In another embodiment, the method and apparatus may be implemented in a sensing device, which outputs raw capacitance data to a host, where the host processes the capacitance data to compensate for quiescent and stray capacitance, and calculates x/y movement and detects gestures by processing the capacitance data. Alternatively, the method and apparatus may be implemented in a sensing device, which outputs pre-processed capacitance data to a host, where the sensing device processes the capacitance data to compensate for quiescent and stray capacitance, and the host calculates x/y movement and detects gestures from the pre-processed capacitance data. Alternatively, other configurations are possible.

The electronic system that includes the embodiments described herein may be implemented in a conventional laptop. Alternatively, it may be implemented in a wired or wireless keyboard, which is itself connected to a host. In such an implementation, the processing described above as being performed by the “host” may be performed in part or in whole by the keyboard controller, which may then pass fully processed, pre-processed or unprocessed data to the system host. In another embodiment, the embodiments may be implemented in a mobile handset (e.g., cellular or mobile phone) or other electronic devices.

Capacitance sensor 201 may be integrated into the processing device 210, or alternatively, in a separate IC. Alternatively, descriptions of capacitance sensor 201 may be generated and compiled for incorporation into other integrated circuits. For example, behavioral level code describing capacitance sensor 201, or portions thereof, may be generated using a hardware description language, such as VHDL or Verilog, and stored to a machine-accessible medium (e.g., Flash ROM, CD-ROM, hard disk, floppy disk, etc.). Furthermore, the behavioral level code can be compiled into a netlist, or even a circuit layout and stored to a machine-accessible medium. The behavioral level code, the netlist, and the circuit layout all represent various levels of abstraction to describe capacitance sensor 201.

It should be noted that the components of electronic system 200 may include all the components described above. Alternatively, electronic system 200 may include only some of the components described above, or include additional components not listed herein.

In one embodiment, electronic system 200 is implemented in a notebook computer. Alternatively, the electronic device may be used in other applications, such as a mobile handset, a PDA, a kiosk, a keyboard, a television, a remote control, a monitor, a handheld multi-media device, a handheld video player, a handheld gaming device, or a control panel.

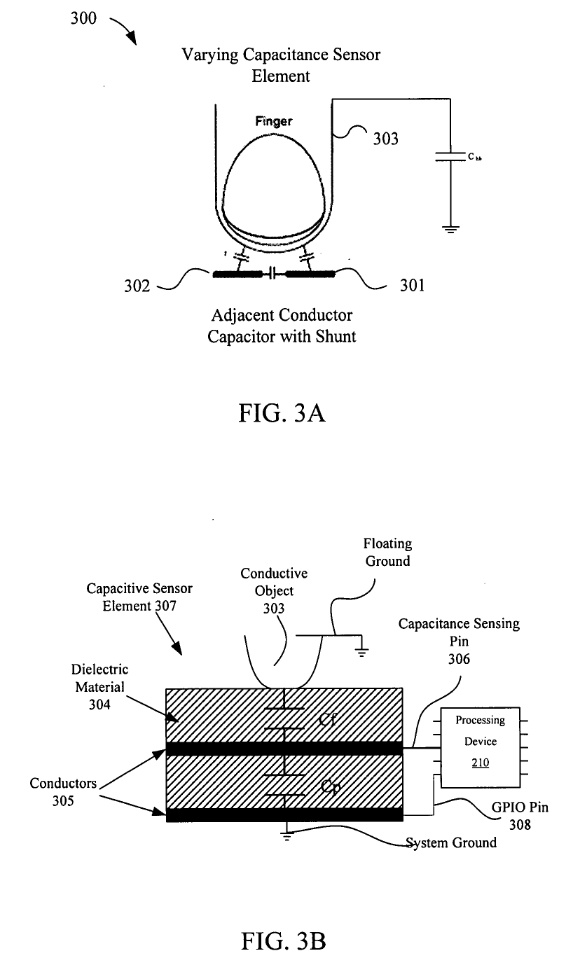

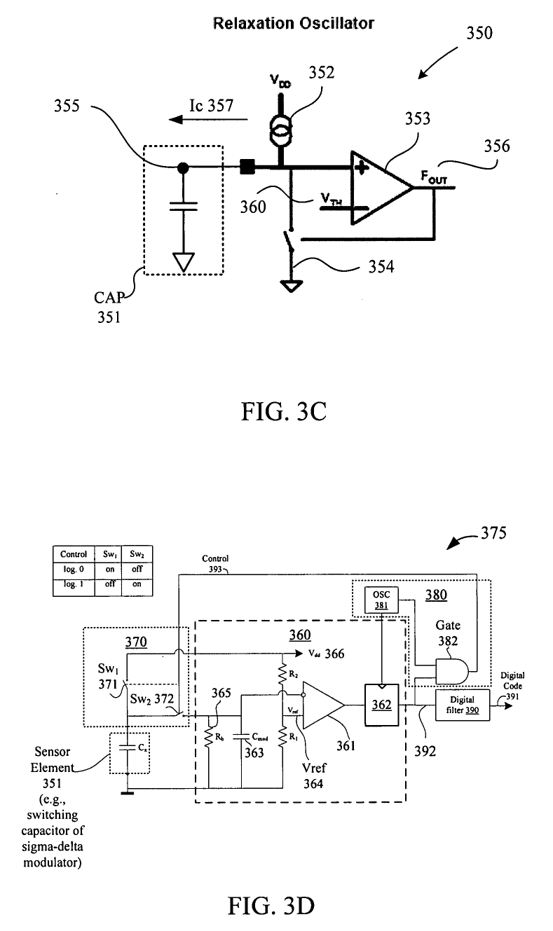

In one embodiment, capacitance sensor 201 is a capacitance sensing relaxation oscillator (CSR), as described below with respect to FIG. 3C. The CSR may be coupled to an array of sensor elements using a current-programmable relaxation oscillator, an analog multiplexer, digital counting functions, and high-level software routines to compensate for environmental and physical sensor element variations. The sensor array may include combinations of independent sensor elements, sliding sensor elements (e.g., touch-sensor slider), and touch-sensor sensor element pads (e.g., touch pad or touch screen) implemented as a pair of orthogonal sliding sensor elements. The CSR may include physical, electrical, and software components. The physical components may include the physical sensor element itself, typically a pattern constructed on a PCB with an insulating cover, a flexible membrane, or a transparent overlay. The electrical component may include an oscillator or other means to convert a capacitance into a measured value. The electrical component may also include a counter or timer to measure the oscillator output. The software component may include detection and compensation algorithms to convert the count value into a sensor element detection decision (also referred to as switch detection decision). For example, in the case of slider sensor elements or X-Y touch-sensor sensor element pads, a calculation for finding position of the conductive object to greater resolution than the physical pitch of the sensor elements may be used.

It should be noted that there are various known methods for measuring capacitance. Although some embodiments described herein are described using a relaxation oscillator, the present embodiments are not limited to using relaxation oscillators, but may include other methods, such as current versus voltage phase shift measurement, resistor-capacitor charge timing, capacitive bridge divider, charge transfer, successive approximation, sigma-delta modulators (illustrated below with respect to FIG. 3D), charge-accumulation circuits, field effect, mutual capacitance, or the like. It should be noted however, instead of evaluating the raw counts relative to a threshold, the capacitance sensor may be evaluating other measurements to determine the user interaction. For example, in the capacitance sensor having a sigma-delta modulator, the capacitance sensor is evaluating the ratio of pulse widths of the output, instead of the raw counts being over a certain threshold.

The current versus voltage phase shift measurement may include driving the capacitance through a fixed-value resistor to yield voltage and current waveforms that are out of phase by a predictable amount. The drive frequency can be adjusted to keep the phase measurement in a readily measured range. The resistor-capacitor charge timing may include charging the capacitor through a fixed resistor and measuring timing on the voltage ramp. Small capacitance values may require very large resistors for reasonable timing. The capacitive bridge divider may include driving the capacitor under test through a fixed reference capacitor. The reference capacitor and the capacitor under test form a voltage divider. The voltage signal may be recovered with a synchronous demodulator, which may be done in the processing device 210. The charge transfer may be conceptually similar to an R-C charging circuit. In this method, C_{P} is the capacitance being sensed. C_{SUM} is the summing capacitor, into which charge is transferred on successive cycles. At the start of the measurement cycle, the voltage on C_{SUM} is discharged. The voltage on C_{SUM} increases exponentially (and only slightly) with each clock cycle. The time for this voltage to reach a specific threshold is measured with a counter. Additional details regarding these alternative embodiments have not been included so as to not obscure the present embodiments, and because these alternative embodiments for measuring capacitance are known by those of ordinary skill in the art.

FIG. 3A illustrates a varying capacitance sensor element. In its basic form, a capacitance sensor element 300 is a pair of adjacent conductors 301 and 302. There is a small edge-to-edge capacitance, but the intent of sensor element layout is to minimize the parasitic capacitance C_{P} between these conductors. When a conductive object 303 (e.g., finger) is placed in proximity to the two conductors 301 and 302, there is a capacitance between electrode 301 and the conductive object 303 and a similar capacitance between the conductive object 303 and the other electrode 302. The capacitance between the electrodes when no conductive object 303 is present is the base capacitance C_{P} that may be stored as a baseline value. The capacitance value C_{F} represents the capacitance from conductor 301 to conductive object 303 then to conductor 302. There is also a total capacitance (C_{P}+C_{F}) on the sensor element 300 when the conductive object 303 is present on or in close proximity to the sensor element 300. The baseline capacitance value C_{P} may be subtracted from the total capacitance when the conductive object 303 is present to determine the change in capacitance (e.g., capacitance variation C_{F}) when the conductive object 303 is present and when the conductive object 303 is not present on the sensor element. Effectively, the capacitance variation C_{F} can be measured to determine whether a conductive object 303 is present or not (e.g., sensor activation) on the sensor element 300. In the case of the finger as a conductive object 303, the conductive object 303 is usually grounded via the human body's capacitance to ground. In this case, the conductive surface of the sensor element is physically and electrically isolated from the grounded human body connection. The C_{P} connection can be modeled two different ways and may make a significant difference in sensitivity.

Capacitance sensor element 300 may be used in a capacitance sensor array. The capacitance sensor array is a set of capacitors where one side of each capacitor is connected to a system ground. When the capacitance sensor element 300 is used in the sensor array, when the conductor 301 is sensed, the conductor 302 is connected to ground, and when the conductor 302 is sensed, the conductor 301 is connected to ground. Alternatively, when the sensor element is used for a touch-sensor button, the sensor element is sensed and the sensed button area may be surrounded by a fixed ground. The presence of the conductive object 303 increases the capacitance (C_{P}+C_{F}) of the sensor element 300 to ground. Determining sensor element activation is then a matter of measuring change in the capacitance (C_{F}) or capacitance variation. Sensor element 300 is also known as a grounded variable capacitor.

The conductive object 303 in this embodiment has been illustrated as a finger. Alternatively, this technique may be applied to any conductive object, for example, a conductive door switch, position sensor, or conductive pen in a stylus tracking system (e.g., stylus).

FIG. 3B illustrates one embodiment of a capacitance sensor element 307 coupled to a processing device 210. Capacitance sensor element 307 illustrates the capacitance as seen by the processing device 210 on the capacitance sensing pin 306. As described above, when a conductive object 303 (e.g., finger) is placed in proximity to one of the conductors 305, there is a capacitance, C_{F}, between the one of the conductors 305 and the conductive object 303 with respect to ground. This ground, however, may be a floating ground. Also, there is a capacitance, C_{P}, between the conductors 305, with one of the conductors 305 being connected to a system ground. The grounded conductor may be coupled to the processing device 210 using GPIO pin 308. The conductors 305 may be metal, or alternatively, the conductors may be conductive ink (e.g., carbon ink, silver ink), conductive ceramic (e.g., transparent conductors of indium tin oxide (ITO)), conductive polymers, or the like. In one embodiment, the grounded conductor may be an adjacent sensor element that is grounded while the capacitance on the neighboring sensor element is measured. Alternatively, the grounded conductor may be other grounding mechanisms, such as a surrounding ground plane. Accordingly, the processing device 210 can measure the change in capacitance, capacitance variation C_{F}, as the conductive object 303 is in proximity to one of the conductors 305. Above and below the conductor that is closest to the conductive object 303 is dielectric material 304. The dielectric material 304 above the conductor 305 can be an overlay. The overlay may be non-conductive material used to protect the circuitry from environmental conditions and electrostatic discharge (ESD), and to insulate the user's finger (e.g., conductive object 303) from the circuitry. Capacitance sensor element 307 may be a sensor element of a touch-sensor pad, a touch-sensor slider, a touch-sensor button, or the like.

FIG. 3C illustrates one embodiment of a relaxation oscillator. The relaxation oscillator 350 is formed by the capacitance to be measured on capacitor 351, a charging current source 352, a comparator 353, and a reset switch 354 (also referred to as a discharge switch). It should be noted that capacitor 351 is representative of the capacitance measured on a sensor element of a sensor array. The relaxation oscillator is coupled to drive a charging current (Ic) 357 in a single direction onto a device under test (“DUT”) capacitor, capacitor 351. As the charging current accumulates charge on the capacitor 351, the voltage across the capacitor increases with time as a function of Ic 357 and its capacitance C. Equation (1) describes the relation between current, capacitance, voltage, and time for a charging capacitor.

CdV=I_{C}dt (1)

The relaxation oscillator begins by charging the capacitor 351, at a fixed current Ic 357, from a ground potential or zero voltage until the voltage across the capacitor 351 at node 355 reaches a reference voltage or threshold voltage, V_{TH} 360. At the threshold voltage V_{TH} 360, the relaxation oscillator allows the accumulated charge at node 355 to discharge (e.g., the capacitor 351 to “relax” back to the ground potential) and then the process repeats itself. In particular, the output of comparator 353 asserts a clock signal F_{OUT} 356 (e.g., F_{OUT} 356 goes high), which enables the reset switch 354. This discharges the capacitor at node 355 to ground and the charge cycle starts again. The relaxation oscillator outputs a relaxation oscillator clock signal (F_{OUT} 356) having a frequency (f_{RO}) dependent upon capacitance C of the capacitor 351 and charging current Ic 357 of the form of equation (2).

$${f}_{RO} = \frac{i}{C * {V}_{TH}} \qquad ( 2 )$$

The comparator trip time of the comparator 353 and reset switch 354 add a fixed delay. The output of the comparator 353 is synchronized with a reference system clock to guarantee that the reset time is long enough to completely discharge capacitor 351. This sets a practical upper limit to the operating frequency. For example, if capacitance C of the capacitor 351 changes, then f_{RO} changes proportionally according to Equation (2). By comparing f_{RO} of F_{OUT} 356 against the frequency (f_{REF}) of a known reference system clock signal (REF CLK), the change in capacitance ΔC can be measured. This is typically done by counting the number (N) of REF CLKs in an integer number of f_{RO} periods and storing the result as a digital count (n_{RO}), as in equations (3) and (4).

$$\begin{matrix}{n}_{RO} = \frac{N * {f}_{REF}}{{f}_{RO}} & ( 3 ) \\ {n}_{RO} = \frac{N * C * {V}_{TH} * {f}_{REF}}{i} & ( 4 )\end{matrix}$$

In one embodiment, a frequency counter may be coupled to receive relaxation oscillator clock signal (F_{OUT} 356) and continuously monitor the frequency, and output a signal indicative of the difference Δf between the current frequency and a stored value indicative of a baseline capacitance.

In one exemplary embodiment, the relaxation oscillator 350 may be built using a programmable timer (e.g., 555 timer) to implement the comparator 353 and reset switch 354. Alternatively, the relaxation oscillator 350 may be built using other circuitry. Relaxation oscillators are known by those of ordinary skill in the art, and accordingly, additional details regarding their operation have not been included so as to not obscure the present embodiments.

The capacitor charging current for the relaxation oscillator 350 may be generated in a register programmable current output DAC (also known as IDAC). Accordingly, the current source 352 may be a current DAC or IDAC. The IDAC output current may be set by an 8-bit value provided by the processing device 210, such as from the processing core 202. The 8-bit value may be stored in a register, in memory, or the like.

In many capacitance sensor element designs, the two “conductors” (e.g., 301 and 302) of the sensing capacitor are actually adjacent sensor elements that are electrically isolated (e.g., PCB pads or traces), as indicated in FIG. 3A. Typically, one of these conductors is connected to a system ground. Layouts for touch-sensor slider (e.g., linear slide sensor elements) and sensing device applications have sensor elements that may be immediately adjacent. In these cases, all of the sensor elements that are not active are connected to a system ground through the GPIO 207 of the processing device 210 dedicated to that pin. The actual capacitance between adjacent conductors is small (C_{P}), but the capacitance of the active conductor (and its PCB trace back to the processing device 210) to ground, when detecting the presence of the conductive object 303, may be considerably higher (C_{P}+C_{F}). The capacitance of two parallel conductors is given by the following equation:

$$C = {ɛ}_{0} \cdot {ɛ}_{R} \cdot \frac{A}{d} = {ɛ}_{R} \cdot 8.85 \cdot \frac{A}{d} pF \qquad ( 5 )$$

The dimensions of equation (5) are in farads. This is a very simple model of the capacitance. The reality is that there are fringing effects that substantially increase the sensor element-to-ground (and PCB trace-to-ground) capacitance.

There is some variation of sensor element sensitivity as a result of environmental factors. A baseline update routine, which compensates for this variation, may be provided in the high-level APIs.

As described above with respect to the relaxation oscillator 350, when a finger or conductive object 303 is placed on the sensor element, the capacitance increases from C_{P} to C_{P}+C_{F} so the relaxation oscillator output signal 356 (F_{OUT}) decreases in frequency. The relaxation oscillator output signal 356 (F_{OUT}) may be fed to a digital counter for measurement. There are two methods for counting the relaxation oscillator output signal 356: frequency measurement and period measurement. Additional details of the relaxation oscillator and digital counter are known by those of ordinary skill in the art, and accordingly a detailed description regarding them has not been included. It should also be noted, that the embodiments described herein are not limited to using relaxation oscillators, but may include other sensing circuitry for measuring capacitance, such as current versus voltage phase shift measurement, resistor-capacitor charge timing, capacitive bridge divider, charge transfer, sigma-delta modulators, charge-accumulation circuits, field effect, mutual capacitance, or the like.

FIG. 3D illustrates a schematic of one embodiment of a circuit 375 including a sigma-delta modulator 360 and a digital filter 390 for measuring capacitance on a sensor element 351. Circuit 375 includes a switching circuit 370, switching clock source 380, sigma-delta modulator 360, and digital filter 390 for measuring the capacitance on sensor element 351. Sensor element 351 may be a sensor element of a sensor array, and is represented as a switching capacitor C_{X} in the modulator feedback loop. Alternatively, sensor element 351 may be a single sensor element, such as used in a touch-sensor button. Switching circuit 370 includes two switches Sw₁ 371 and Sw₂ 372. The switches Sw₁ 371 and Sw₂ 372 operate in two, non-overlapping phases (also known as break-before-make configuration). These switches together with sensing capacitor Cₓ 351 form the switching capacitor equivalent resistor, which provides the modulator capacitor C_{mod} 363 of sigma-delta modulator 360 charge current (as illustrated in FIG. 3D) or discharge current (not illustrated) during one of the two phases.

The sigma-delta modulator 360 includes the comparator 361, latch 362, modulator capacitor C_{mod} 363, modulator feedback resistor 365, which may also be referred to as bias resistor 365, and voltage source 366. The output of the comparator may be configured to toggle when the voltage on the modulator capacitor 363 crosses a reference voltage 364. The reference voltage 364 may be a pre-programmed value, and may be configured to be programmable. The sigma-delta modulator 360 also includes a latch 362 coupled to the output of the comparator 361 to latch the output of the comparator 361 for a given amount of time, and provide as an output, output 392. The latch may be configured to latch the output of the comparator based on a clock signal from the gate circuit 382 (e.g., oscillator signal from the oscillator 381). In another embodiment, the sigma-delta modulator 360 includes a synchronized latch that operates to latch an output of the comparator for a pre-determined length of time. The output of the comparator may be latched for measuring or sampling the output signal of the comparator 361 by the digital filter 390.

Sigma-delta modulator 360 is configured to keep the voltage on the modulator capacitor 363 close to reference voltage V_{ref} 364 by alternatively connecting the switching capacitor resistor (e.g., switches Sw₁ 371 and Sw₂ 372 and sensing capacitor Cₓ 351) to the modulator capacitor 363. The output 392 of the sigma-delta modulator 360 (e.g., output of latch 362) is feedback to the switching clock circuit 380, which controls the timing of the switching operations of switches Sw₁ 371 and Sw₂ 372 of switching circuit 370. For example, in this embodiment, the switching clock circuit 380 includes an oscillator 381 and gate 382. Alternatively, the switching clock circuit 380 may include a clock source, such as a spread spectrum clock source (e.g., pseudo-random signal (PRS)), a frequency divider, a pulse width modulator (PWM), or the like. The output 392 of the sigma-delta modulator 360 is used with an oscillator signal to gate a control signal 393, which switches the switches Sw₁ 371 and Sw₂ 372 in a non-overlapping manner (e.g., two, non-overlapping phases). The output 392 of the sigma-delta modulator 360 is also output to digital filter 390, which filters and/or converts the output into the digital code 391.

In one embodiment of the method of operation, at power on, the modulator capacitor 363 has zero voltage and switching capacitor resistor (formed by sensing capacitor Cx 351, and switches Sw₁ 371 and Sw₂ 372) is connected between Vdd line 366 and modulator capacitor 363. This connection allows the voltage on the modulator capacitor 363 to rise. When this voltage reaches the comparator reference voltage, V_{ref} 364, the comparator 361 toggles and gates the control signal 393 of the switches Sw₁ 371 and Sw₂ 372, stopping the charge current. Because the current via bias resistor R_{b} 365 continues to flow, the voltage on modulator capacitor 363 starts decreases. When the voltage decreases below the reference voltage 364, the output of the comparator 361 switches again, enabling the modulator capacitor 363 to start charging. The latch 362 and the comparator 361 set the sample frequency of the sigma-delta modulator 360.

The digital filter 390 is coupled to receive the output 392 of the sigma-delta modulator 360. The output 392 of the sigma-delta modulator 360 may be a single bit bit-stream, which can be filtered and/or converted to numerical values using a digital filter 390. In one embodiment, the digital filter 390 is a counter. In another embodiment, the standard Sync digital filter can be used. In another embodiment, the digital filter is a decimator. Alternatively, other digital filters may be used for filtering and/or converting the output 392 of the sigma-delta modulator 360 to provide the digital code 391. It should also be noted that the output 392 may be output to the decision logic 402 or other components of the processing device 210, or to the decision logic 451 or other components of the host 250 to process the bitstream output of the sigma-delta modulator 360.

Described below are the mathematical equations that represent the operations of FIG. 3D. During a normal operation mode, the sigma-delta modulator 360 keeps these currents substantially equal on average by keeping the voltage on the modulator 363 equal to, or close to, the reference voltage V_{ref} 364. The current of the bias resistor R_{b} 365 is:

$${I}_{Rb} = \frac{{V}_{c mod}}{{R}_{b}} \qquad ( 6 )$$

The sensing capacitor Cₓ 351 in the switched-capacitor mode has equivalent resistance:

$${R}_{c} = \frac{1}{{f}_{s} {C}_{x}} \qquad ( 7 )$$

where fₛ is the operation frequency of the switches (e.g., switching circuit 370). If the output 392 of the sigma-delta modulator 360 has a duty cycle of d_{mod}, the average current of the switching capacitor 351 can be expressed in the following equation (8):

$${I}_{c} = {d}_{mod} \frac{{V}_{dd} - {V}_{C mod}}{{R}_{c}} \qquad ( 8 )$$

In the operation mode, I_{Rb}=I_{c}, V_{C mod}=V_{ref} or:

$$\frac{{V}_{ref}}{{R}_{b}} = {d}_{mod} \frac{{V}_{dd} - {V}_{ref}}{{R}_{c}} \qquad ( 9 )$$

or taking into account that the reference voltage 364 is part of supply voltage:

$${V}_{ref} = {k}_{d} {V}_{dd} ; {k}_{d} = \frac{{R}_{1}}{{R}_{1} + {R}_{2}} \qquad ( 10 )$$

The Equation (9) can be rewritten in the following form:

$${d}_{mod} = \frac{{R}_{c}}{{R}_{b}} \frac{{k}_{d}}{1 - {k}_{d}} = \frac{1}{{f}_{s} {R}_{b}} \frac{{k}_{d}}{1 - {k}_{d}} \frac{1}{{C}_{x}} \qquad ( 11 )$$

The Equation (11) determines the minimum sensing capacitance value, which can be measured with the proposed method at given parameters set:

$${d}_{mod} \leq 1 , or \text{:} {C}_{x min} = \frac{1}{{f}_{s} {R}_{b}} \frac{{k}_{d}}{1 - {k}_{d}} \qquad ( 12 )$$

The resolution of this method may be determined by the sigma-delta modulator duty cycle measurement resolution, which is represented in the following equations:

$$Δ {d}_{mod} = β \frac{Δ {C}_{x}}{{C}_{x}^{2}} ; \\ β = \frac{1}{{f}_{s} {R}_{b}} \frac{{k}_{d}}{1 - {k}_{d}} \qquad ( 13 )$$

or after rewriting relatively ΔCₓ, we obtain:

$$Δ {C}_{x} = \frac{1}{β} Δ {d}_{mod} {C}_{x}^{2} \qquad ( 14 )$$

In one exemplary embodiment, the resistance of the bias resistor 365 is 20 k ohms (R_{b}=20 k), the operation frequency of the switches is 12 MHz (fₛ=12 MHz), the capacitance on the switching capacitor 351 is 15 picofarads (Cₓ=15 pF), and the ratio between Vdd 366 and the voltage reference 364 is 0.25 (k_{d}=0.25), the duty cycle has a 12-bit resolution and the capacitance resolution is 0.036 pF.

In some embodiments of capacitive sensing applications, it may be important to get fast data measurements. For example, the modulator can operate at sample frequency 10 MHz (period is 0.1 microseconds (μs)), for the 12-bit resolution sample, and digital filter as single-type integrator/counter the measurement time is approximately 410 μs (e.g., 2¹²*0.1 μs=410 μs). For faster measurement speeds at same resolutions, other types of digital filters may be used, for example, by using the Sinc2 filter, the scanning time at the same resolution may be reduced approximately 4 times. Using this configuration, the sensing method should have suitable measurement speed. A good measurement rate may be accomplished by using a double integrator as the digital filter 390.

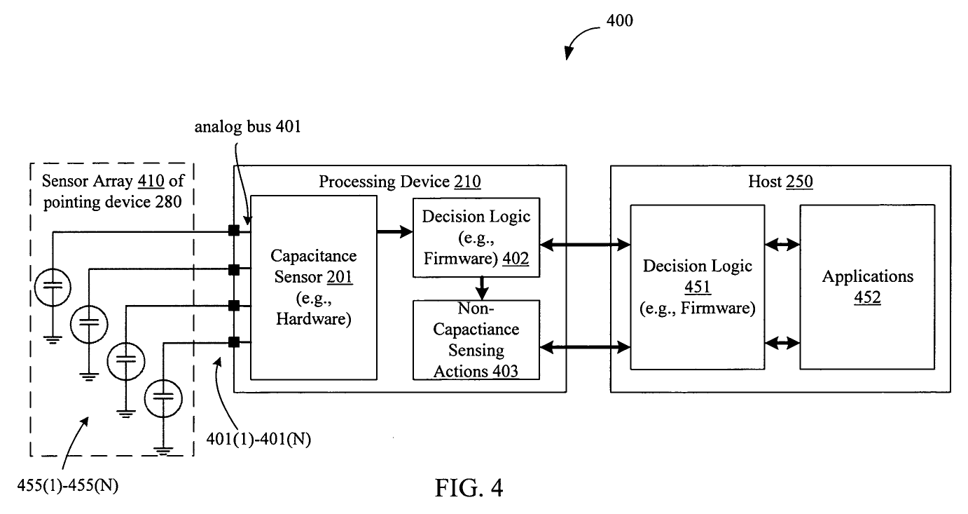

FIG. 4 illustrates a block diagram of one embodiment of an electronic device 400 including a processing device 210 that includes a capacitance sensor 201 for measuring the capacitance on a sensor array 410. The electronic device 400 includes the sensor array 410, processing device 210, and host 250. The sensor array 410 may be a linear sensor array, two linear sensor arrays, a radial sensor array, a figure-eight shaped sensor array, as described herein, or the like. The sensor array 410 is coupled to processing device 210 via an analog bus 401 having multiple pins 401(1)-401(N). Each sensor element is represented as a capacitor, as described above with respect to FIG. 3B. Sensor array 410 includes sensor elements 455(1)-455(N), where N is a positive integer value that represents the number of sensor elements of the sensor array 410.

In one embodiment, the capacitance sensor 201 includes a selection circuit (not illustrated). The selection circuit is coupled to the sensor elements 455(1)-455(N) and the sensing circuitry of the capacitance sensor 201. Selection circuit may be used to allow the capacitance sensor to measure capacitance on multiple sensor elements. The selection circuit may be configured to sequentially select a sensor element of the multiple sensor elements to provide the charge current and to measure the capacitance of each sensor element. In one exemplary embodiment, the selection circuit is a multiplexer array. Alternatively, the selection circuit may be other circuitry inside or outside the capacitance sensor 201 to select the sensor element to be measured. In another embodiment, one capacitance sensor 201 is used to measure capacitance on all or less than all of the sensor elements of the sensor array 410. Alternatively, multiple capacitance sensors 201 may be used to measure capacitance on the sensor elements of the sensor array. The multiplexer array may also be used to connect the sensor elements that are not being measured to the system ground. This may be done in conjunction with a dedicated pin in the GP10 port 207. In another embodiment, the capacitance sensor 201 may be configured to simultaneously sense the sensor elements, as opposed to being configured to sequentially scan the sensor elements as described above.

In one embodiment, the processing device 210 further includes a decision logic block 402. The operations of decision logic block 402 may be implemented in firmware; alternatively, it may be implemented in hardware or software. The decision logic block 402 may be configured to receive the digital code or counts from the capacitance sensor 201, and to determine the state of the sensor array 410, such as whether a conductive object 303 is detected on or in proximity to the sensor array 410, whether a conductive object 303 is detected on the sensor array, where the conductive object 303 was detected on the sensor array (e.g., determining the X-, Y-coordinates of the presence of the conductive object 303), determining absolute or relative position of the conductive object 303, whether the conductive object 303 is performing a pointer operation, whether a gesture has been recognized on the sensor array 410 (e.g., click, double-click, movement of the pointer, scroll-up, scroll-down, scroll-left, scroll-right, step back, step forward, tap, push, hop, zigzag gestures, or the like), or the like.

In another embodiment, instead of performing the operations of the decision logic 402 in the processing device 210, the processing device 201 may send the raw data to the host 250, as described above. Host 250, as illustrated in FIG. 4, may include decision logic 451. The operations of decision logic 451 may also be implemented in firmware, hardware, and/or software. Also, as described above, the host may include high-level APIs in applications 452 that perform routines on the received data, such as compensating for sensitivity differences, other compensation algorithms, baseline update routines, start-up and/or initialization routines, interpolation operations, scaling operations, or the like. The operations described with respect to the decision logic 402 may be implemented in decision logic 451, applications 452, or in other hardware, software, and/or firmware external to the processing device 210.

In another embodiment, the processing device 210 may also include a non-capacitance sensing actions block 403. This block may be used to process and/or receive/transmit data to and from the host 250. For example, additional components may be implemented to operate with the processing device 210 along with the sensor array 410 (e.g., keyboard, keypad, mouse, trackball, LEDs, displays, or the like).

At startup (or boot) the sensor elements (e.g., capacitors 455(1)-(N)) are scanned and the digital code or count values for each sensor element with no activation are stored as a baseline array (C_{P}). The presence of a finger on the sensor element or in proximity to the sensor element is determined by the difference in counts between a stored value for no sensor element activation and the acquired value with sensor element activation, referred to here as Δn. The sensitivity of a single sensor element is approximately:

$$\frac{Δ n}{n} = \frac{{C}_{F}}{{C}_{P}} \qquad ( 14 )$$

The value of Δn should be large enough for reasonable resolution and clear indication of sensor element activation (e.g., button activation). This drives sensor element construction decisions. C_{F} should be as large a fraction of C_{P} as possible. Since C_{F} is determined by finger area and distance from the finger to the sensor element's conductive traces (through the over-lying insulator), the baseline capacitance C_{P} should be minimized. The baseline capacitance C_{P} includes the capacitance of the sensor element pad plus any parasitics, including routing and chip pin capacitance.

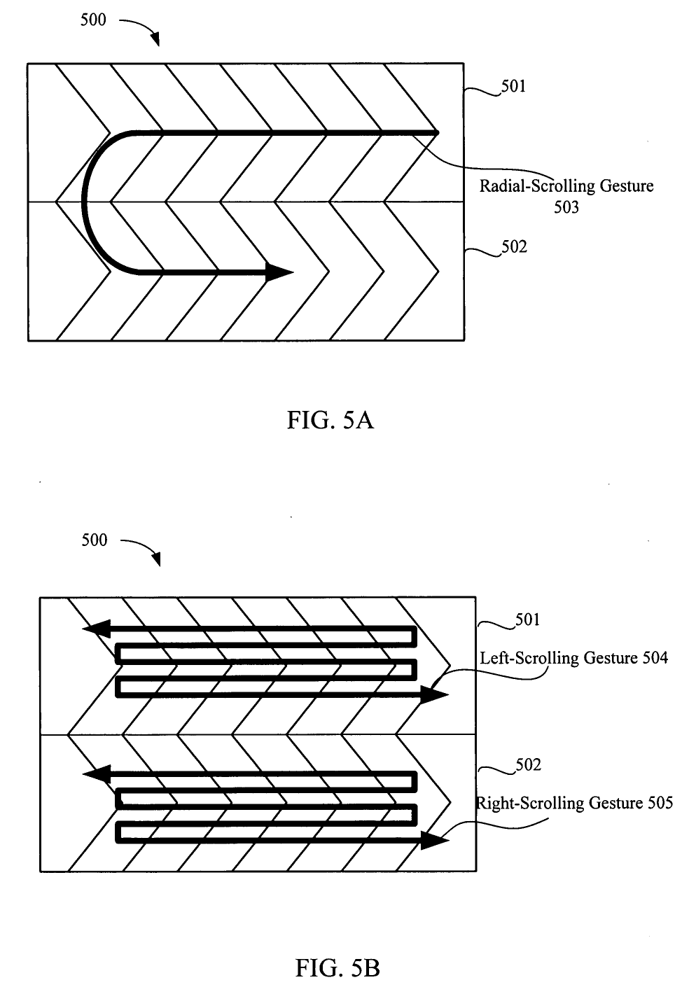

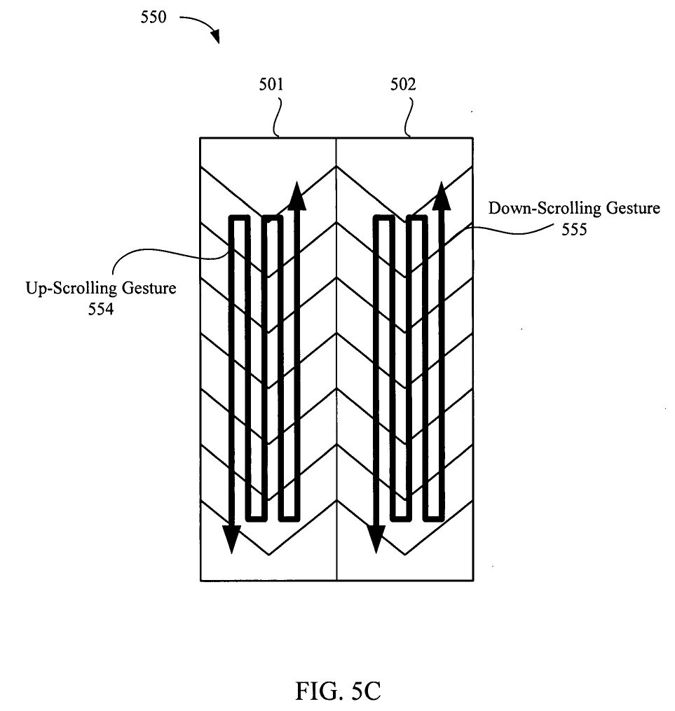

FIGS. 5A and 5B illustrate two linear slider arrays to detect radial scrolling gestures and left and right scrolling gestures according to one embodiment of the present invention. A touch-sensor slider 500 includes two linear slider arrays 501 and 502. The linear slider arrays 501 and 502 are similar to the touch-sensor slider 230 of FIG. 2. The linear slider arrays 501 and 502 are set up as two separate arrays adjacent to one another. The processing device 210 (not illustrated in FIGS. 5A and 5B) is configured to detect a presence of a conductive object 303 on the linear slider array 501 and 502. The processing device 210 is also configured to detect position, movement, direction, and/or speed of the conductive object 303 on the linear slider arrays 501 and 502. In one embodiment, if the processing device 210 detects that the conductive object 303 is moving in a first direction on the slider 501, and then in another direction on the slider 502, a radial-scrolling gesture 503 is detected, as illustrated in FIG. 5A. The function associated with the radial-scrolling gesture 503 may be performed. In one embodiment, the radial-scrolling gesture 503 is a radial-scrolling gesture that is normally detected on a radial sensor array, such as scrolling up or down in a menu. Alternatively, the radial-scrolling gesture 503 may be other radial gestures known to those of ordinary skill in the art. In one embodiment, if the processing device 210 detects the conductive object 303 initially moving to the left from a starting position that is on the right of the linear sensor array 501, and then transitioning to the left side of the linear sensor array 502, a radial, scroll-left gesture may be detected. Similarly, if the conductive object 303 is initially moving to the right from a starting position that is on the left of the linear sensor array 501, and then transitioning to the right side of the linear sensor array 502, a radial, scroll-right gesture may be detected. In another embodiment, the processing device may detect radial-scrolling gestures when the conductive object 303 moves from the linear sensor array 502 to the linear sensor array 501. Alternatively, other types of gestures may be detected when the conductive object 303 moves on and in between the linear sensor arrays 501 and 502.

In one embodiment, using the linear sensor arrays 501 and 502 together allows a radial slider interface. In another embodiment, using the two linear sensor arrays 501 and 502 as separate sliders allows easier scrolling in either direction using a more simple interaction than a circular movement used on conventional radial sliders. The simple interaction may be moving the conductive object 303 back and forth, such as left and right, or up and down, on one linear sensor array to trigger a first scroll operation, such as a scroll-left operation, and moving the conductive object 303 back and forth, such as left and right, or up and down, on the other linear sensor array to trigger a second scroll operation, such as a scroll-right operation. Alternatively, the linear sensor arrays 501 and 502 may be configured to detect other types of gestures that trigger different type of scrolling gestures as known to those of ordinary skill in the art.

In another embodiment, if the processing device 210 detects that the conductive object 303 is moving in a first direction from a first position, and then in a second direction on the same linear slider array, a scrolling gesture is detected. For example, if the processing device 210 detects the conductive object 303 moving on the linear sensor array 501, a left-scrolling gesture 504 is detected, and if the processing device 210 detects the conductive object 303 moving on the linear slider array 502, a right-scrolling gesture 505 is detected, such as illustrated in FIG. 5B. In one embodiment, the first and second directions are substantially opposite directions, such as left and right, up and down, or the like. Alternatively, the first and second directions are not substantially opposite directions. It should be noted that although the linear slider arrays 501 and 502 are configured to be used in detecting the left-scrolling gesture 504 and the right-scrolling gesture 505, respectively, the processing device 210 may be configured to detect the right-scrolling gesture 505 on the linear slider array 501 and the left-scrolling gesture 504 on the linear slider array 502.

In another embodiment, the presence of the conductive object 303 is detected at a first position on the linear sensor array 501, and the scrolling gesture, such as the left-scrolling gesture 504, is detected when the conductive object 303 is moved initially in a first direction (e.g., from a starting position on the right side of the linear sensor array 501 to the left) and subsequently in a second direction (e.g., to the right back towards the starting position). The end of the scrolling gesture is detected when the conductive object 303 is released from the linear sensor array 501. It should be noted that the conductive object 303 may be moved in multiple directions before the conductive object 303 is released, and so long as the conductive object 303 remains on the linear sensor array 501, the scrolling gesture continues to be detected by the processing device 210. Similarly, the conductive object 303 may be moved in multiple directions before the conductive object 303 is released from the linear sensor array 502, and so long as the conductive object 303 remains on the linear sensor array 502, the scrolling gesture continues to be detected by the processing device 210. In another embodiment, the presence of the conductive object 303 is detected at a first position on the linear sensor array 501, and the scrolling gesture, such as the radial-scrolling gesture 503, is detected when the conductive object 303 is moved initially in either direction of the linear sensor array 501 to either direction (e.g., opposite direction than the direction on the linear sensor array 501) on the linear sensor array 502. The end of the radial-scrolling gesture 503 is detected when the conductive object 303 is released from either the linear sensor array 502 or the linear sensor array 501. It should be noted that the conductive object 303 may be moved between the linear sensor arrays 501 and 502 before the conductive object 303 is released, and so long as the conductive object 303 remains on the linear sensor array 501 or the linear sensor array 502, the radial-scrolling gesture 503 continues to be detected by the processing device 210.

FIG. 5C illustrates the two linear sliders of FIG. 5A configured to detect up- and down-scrolling gestures. A touch-sensor slider 550 also includes the two linear slider arrays 501 and 502, however, the linear slider arrays 501 in 502 are disposed to detect up and down movements of the conductive object 303, rather than left and right movements, as illustrated in FIGS. 5A and 5B. In one embodiment, using the linear sensor arrays 501 and 502 together allows a radial slider interface. In another embodiment, using the two linear sensor arrays 501 and 502 as separate sliders allows easier scrolling in either direction using a more simple interaction than a circular movement used on conventional radial sliders, as described above. Alternatively, the linear sensor arrays 501 and 502 of FIG. 5C may be configured to detect other types of gestures that trigger different type of scrolling gestures as known to those of ordinary skill in the art.

In one embodiment, if the processing device 210 detects the conductive object 303 moving on the linear sensor array 501, an up-scrolling gesture 544 is detected, and if the processing device 210 detects the conductive object 303 moving on the linear slider array 502, a down-scrolling gesture 555 is detected. In one embodiment, the first and second directions are substantially opposite directions, such as up and down. Alternatively, the first and second directions are not substantially opposite directions. It should be noted that although the linear slider arrays 501 and 502 are configured to be used in detecting the up-scrolling gesture 554 and the down-scrolling gesture 555, respectively, the processing device 210 may be configured to detect the up-scrolling gesture 554 on the linear slider array 502 and the down-scrolling gesture 555 on the linear slider array 501.

In another embodiment, a radial-scrolling gesture, which is normally detected on a radial sensor array, is detected using the touch-sensor slider 550. Alternatively, the radial-scrolling gesture 503 may be other radial gestures known to those of ordinary skill in the art.

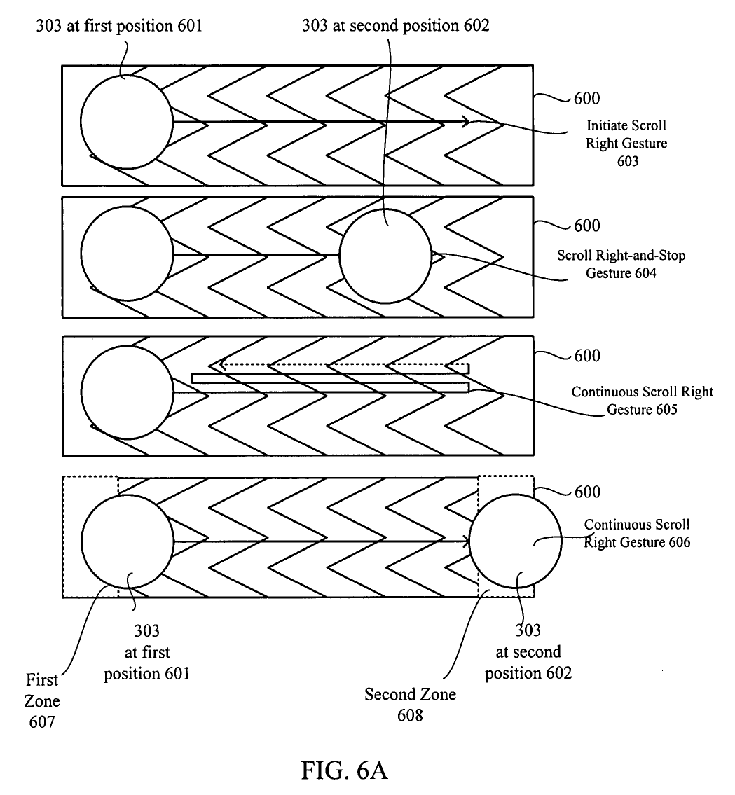

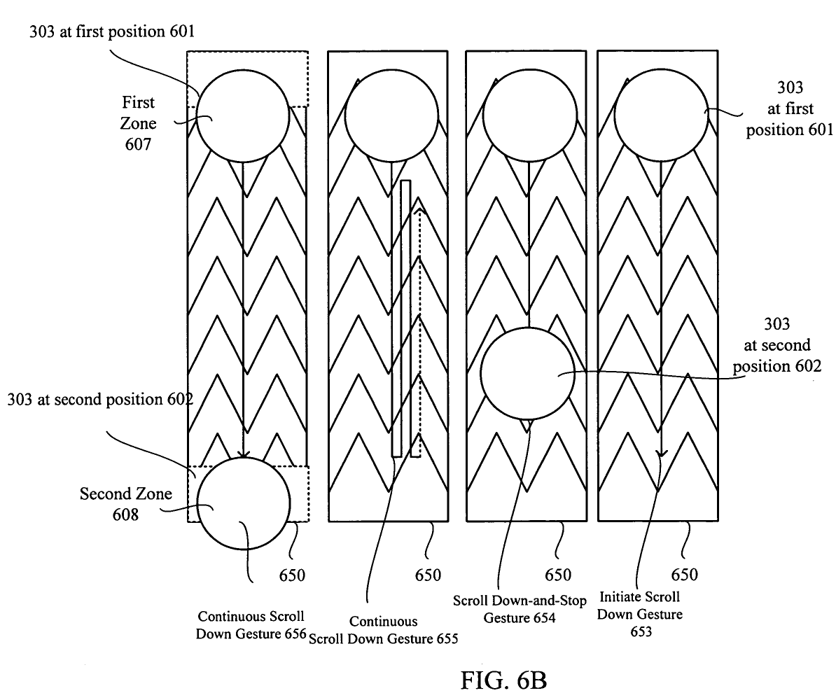

Although the touch-sensor slider 500 has been illustrated and described as two separate arrays, alternatively, the touch-sensor slider 500 or the touch-sensor slider 550 may be one continuous array, such as illustrated in FIG. 6A.

FIG. 6A illustrates a linear sensor array 600 to detect various scrolling gestures 603-606 according to one embodiment of the present invention. The linear slider 600 is a continuous linear slider array. The processing device 210 (not illustrated in FIG. 6A) is configured to detect a presence of a conductive object 303 on the linear slider array 600. The processing device 210 is also configured to detect position, movement, direction, or speed of the conductive object 303 on the linear slider array 600. The processing device 210 is configured to detect various types of scrolling gestures on the linear sensor array 600. In this embodiment, a scroll right gesture 603 is initiated when the conductive object 303 is detected at the first position 601, and subsequently detected as moving to the right of a first position 601 without the conductive object 303 being released from the linear sensor array 600. A scroll right-and-stop gesture 604 is detected when the conductive object 303 is detected at the first position 601, subsequently detected as moving to the right of the first position 601, and subsequently detected as being released from the sensor array at a second position 602 that is to the right of the first position 601.

A continuous scroll right gesture 605 is detected when the conductive object 303 is detected in the first position 601, subsequently detected as initially moving (e.g., detecting an initial motion) to the right of the first position 601, and subsequently detected as moving (e.g., detecting a subsequent motion) in a different direction that the initial motion without the conductive object 303 being released from the sensor array. The subsequent motion may be up or down, right or left motions of the conductive object 303, so long as the conductive object 303 is not released from the sensor array. In one embodiment, the continuous scroll-right gesture 605 is detected when the conductive object 303 is detected as moving to the right initially and then back and forth on the sensor array. The continuous scroll-right gesture 605 continues until the conductive object 303 is released from the sensor array. In another embodiment, the continuous scroll-right gesture 605 is detected when the conductive object 303 is detected as initially moving to the right of the first position 601 without the conductive object 303 being released from the sensor array, and the continuous scroll-right gesture 605 is configured to stop scrolling when the conductive object 303 is released from the sensor array. In another embodiment, after the conductive object 303 is initially moved to the right of the first position 601, subsequently detecting the conductive object 303 moving to the left or right without the conductive object 303 being released from the sensor array.

In another embodiment, a continuous scroll-right gesture 606 is detected when the conductive object 303 is detected in the first position 601 in a first zone 607 of the sensor array, and subsequently detected as moving to the right of the first position 601 at a second position 602 that is in a second zone 608 of the sensor array without the conductive object 303 being released from the sensor array. In this embodiment, the continuous scroll-right gesture 606 is configured to stop scrolling when the conductive object 303 is released from the second position 602 in the second zone 608. In another embodiment, if the conductive object 303 is detected on the linear array 600 as moving to the right, such as from a starting position that is outside the first zone 607, and stops inside the second zone 608 at the second position, then a continuous scroll-right gesture 606 is detected. In this embodiment, the continuous scroll-right gesture 606 is configured to stop scrolling when the conductive object 303 is released from the second position 602 in the second zone 608.

It should be noted that although the embodiments of FIG. 6A are illustrated and described as detecting right-scrolling gestures, in other embodiments, other types of scrolling gestures may be detected, such as scrolling-left gestures, scrolling-up gestures, scrolling-down gestures, or the like.

FIG. 6B illustrates a linear sensor array 650 to detect up- and down-scrolling gestures. In one embodiment, the processing device 210 is configured to detect on the linear sensor array 650 a scroll down gesture 653, a scroll-down-and-stop gesture 654, a continuous scroll down gesture 655, or a continuous scroll down gesture 656 using first and second zones 657 and 658, similarly to detect the gestures described above with respect to FIG. 6A. In other embodiments, other types of gestures are detected on the linear sensor array 650, such as scrolling-up gestures, scrolling-left gestures, scrolling-right gestures, or the like.

It should also be noted even though the embodiments described above are described as detecting scrolling gestures on a single linear array, in other embodiments, the scrolling gestures may be detected on multiple linear arrays, such as on the two linear arrays 501 and 502 of FIGS. 5A-5C. Alternatively, these scrolling gestures can be detected on a radial sensor array, as described below, or the like.

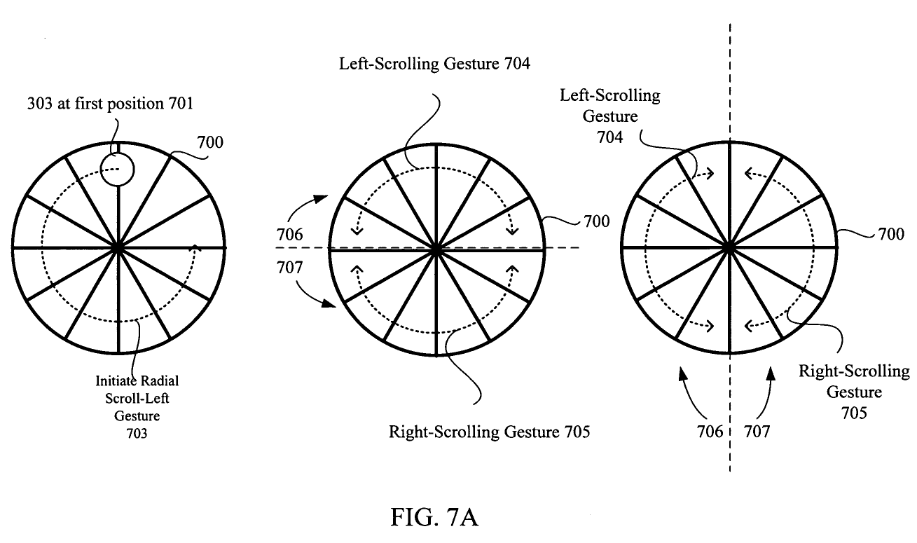

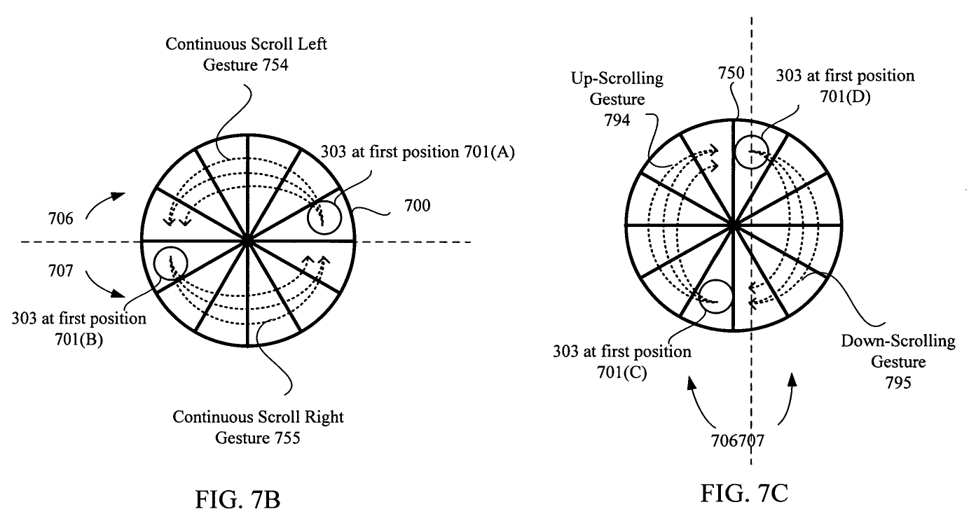

FIG. 7A illustrates a radial sensor array 700 to detect radial-scrolling gestures and left- and right-scrolling gestures according to one embodiment of the present invention. The processing device 210 (not illustrated in FIG. 7A) is configured to detect a presence of a conductive object 303 on the radial slider array 700. The processing device 210 is also configured to detect position, movement, direction, and/or speed of the conductive object 303 on the radial slider array 700. The processing device 210 is configured to detect various types of scrolling gestures on the radial sensor array 700. In this embodiment, a radial scroll-left gesture 703 is initiated when the conductive object 303 is detected at a first position 701, and subsequently detected as moving to counter-clockwise of the first position 701 without the conductive object 303 being released from the radial sensor array 700.

In one embodiment, if the processing device 210 detects that the conductive object 303 is moving in a first direction from the first position 701 on the radial sensor array 700, and then in another direction on the other end from the first position (e.g., bottom half) of the radial sensor array 700, the radial scrolling-left gesture 703 is detected, as illustrated in the left-most radial sensor array 700 of FIG. 7A. The function associated with the radial scrolling-left gesture 703 may be performed. In one embodiment, the radial scrolling-left gesture 703 is a radial scrolling-left gesture that is normally detected on a radial sensor array, such as scrolling up or down in a menu. Alternatively, the radial scrolling-left gesture 703 may be other radial gestures known to those of ordinary skill in the art.

In one embodiment, the radial sensor array 700 provides a radial slider interface, as well as a linear slider interface. The radial slider interface allows radial scrolling gestures to be detected on the radial sensor array, and the linear slider interface allows scrolling gesture, such as left-, right-, up-, and down-scrolling gestures to be detected on the same sensor arrays. The radial slider interface, in another embodiment, using the radial sensor array 700, allows easier scrolling in either direction using a more simple interaction than complete circular movements used on conventional radial sliders, such as used to continuously scroll through a menu. The simple interaction, in this embodiment, is moving the conductive object 303 back and forth, such as left and right, clockwise or counter-clockwise, or up and down, on a first portion of the radial sensor array to trigger a first scroll operation, and on a second portion of the radial sensor array to trigger a second scroll operation. However, unlike the conventional radial sensor arrays that require the user to continuously move the conductive object 303 in at least one rotation on the radial sensor array to perform a continuous scroll operation, the radial slider interface allows the user to move the conductive object 303 back and forth to perform the continuous scroll operation without the conductive object 303 being moved in at least one rotation of the radial sensor array.

The processing device 210 may also be configured to detect other types of scrolling gestures, such as left- and right-scrolling gestures 704, and 705. It should be noted that the left-scrolling gesture 704 and right-scrolling gestures 705 are linear slider operations in one embodiment, and radial slider operations in another embodiment. In another embodiment, the radial sensor array 700 is configured to have two modes, one mode to detect linear slider operations, using the first and second portions 706 and 707 to detect left- and right-scrolling operations, such as described with respect to FIG. 5B, and another mode to detect radial slider operations, such as done by conventional radial sliders.

In one embodiment, the processing device 210 receives signals from the radial sensor array 700 and detects a scroll-left gesture 704 on a first portion 706 of the radial sensor array 700 and a scroll-right gesture 705 on a second portion 707 of the radial sensor array 700. The radial sensor array 700 may be divided into two or more portions to detect various types of scrolling gestures, as well as radial scrolling gestures. In one embodiment, the first and second portions 706 and 707 are designated as the top and bottom halves of the radial sensor array 700 (illustrated in the middle radial sensor array 700 of FIG. 7A). In another embodiment, the first and second portions 706 and 707 are designated as the left and right halves of the radial sensor array 700 (illustrated in the right-most radial sensor array 700 of FIG. 7A). In other embodiments, the processing device 210 receives signals from the radial sensor array 700 and detects up-scrolling or down-scrolling gestures on either one of the first and second portions 706 and 707.

In one embodiment, the processing device 210 receives signals from the radial sensor array 700 and detects a continuous scrolling gesture on the radial sensor array 700 without the conductive object 303 being released from the radial sensor array 700. However, unlike the conventional radial sensor arrays that detect the continuous scroll by the conductive object 303 being moved in at least one rotation of the radial sensor array, the continuous scrolling gesture is detected without the conductive object 303 being moved in at least one rotation of the radial sensor array, such as by detecting back and forth movement in one of the designated portions of the radial sensor array 700, such as portion 706 or portion 707.

FIG. 7B illustrates a radial sensor array 700 to detect radial-scrolling gestures and continuous left- and right-scrolling gestures according to another embodiment of the present invention. In this embodiment, if the processing device 210 (not illustrated in FIG. 7B) detects that the conductive object 303 is moving in a first direction from a first position 701(A) on the first portion 706, and then in a second direction on the first portion 706 of the radial sensor array 700, a continuous scrolling gesture is detected. For example, if the processing device 210 detects the conductive object 303 moving in a first direction on the first portion 706 of the radial sensor array 700, a radial left-scrolling gesture 703 is detected, such as described with respect to FIG. 7A; however, if the processing device 210 detects the conductive object 303 being moved in a second direction on first portion 706 of the radial sensor array 700, a continuous scroll-left gesture 754 is detected. The continuous scroll-left gesture 754 continues to be detected so long as the conductive object 303 remains in the first portion 706 and continues to move back and forth to control the amount and speed of scrolling in the scrolling operation corresponding to the continuous scroll-left gesture 754. Once the conductive object 303 is released from the first portion 706, the continuous scroll operation stops.

Similarly, if the processing device 210 detects that the conductive object 303 is moving in a first direction from a first position 701(B) on the second portion 707, and then in a second direction on the second portion 707 of the radial sensor array 700, a continuous scrolling gesture is detected. For example, if the processing device 210 detects the conductive object 303 moving in a first direction on the second portion 707 of the radial sensor array 700, a radial right-scrolling gesture is detected; however, if the processing device 210 detects the conductive object 303 being moved in a second direction on the second portion 707 of the radial sensor array 700, a continuous scroll-right gesture 755 is detected. The continuous scroll-right gesture 755 continues to be detected so long as the conductive object 303 remains in the second portion 707 and continues to move back and forth to control the amount and speed of scrolling in the scrolling operation corresponding to the continuous scroll-right gesture 755. Once the conductive object 303 is released from the second portion 707, the continuous scroll operation stops.

FIG. 7C illustrates a radial sensor array 750 to detect radial-scrolling gestures and up- and down-scrolling gestures according to another embodiment of the present invention. In this embodiment, if the processing device 210 (not illustrated in FIG. 7C) detects that the conductive object 303 is moving in a first direction from a first position 701(C) on the first portion 706, and then in a second direction on the first portion 706 of the radial sensor array 750, a continuous scrolling gesture is detected. For example, if the processing device 210 detects the conductive object 303 moving in a first direction on the first portion 706 of the radial sensor array 750, a radial left-scrolling gesture 703 is detected, such as described with respect to FIG. 7A; however, if the processing device 210 detects the conductive object 303 being moved in a second direction on first portion 706 of the radial sensor array 750, a continuous scroll-up gesture 794 is detected. The continuous scroll-up gesture 794 continues to be detected so long as the conductive object 303 remains in the first portion 706 and continues to move up and down to control the amount and speed of scrolling in the scrolling operation corresponding to the continuous scroll-up gesture 794. Once the conductive object 303 is released from the first portion 706, the continuous scroll operation stops.

Similarly, if the processing device 210 detects that the conductive object 303 is moving in a first direction from a first position 701(D) on the second portion 707, and then in a second direction on the second portion 707 of the radial sensor array 750, a continuous scrolling gesture is detected. For example, if the processing device 210 detects the conductive object 303 moving in a first direction on the second portion 707 of the radial sensor array 750, a radial right-scrolling gesture is detected; however, if the processing device 210 detects the conductive object 303 being moved in a second direction on the second portion 707 of the radial sensor array 750, a continuous scroll-down gesture 795 is detected. The continuous scroll-down gesture 795 continues to be detected so long as the conductive object 303 remains in the second portion 707 and continues to move up and down to control the amount and speed of scrolling in the scrolling operation corresponding to the continuous scroll-right gesture 755. Once the conductive object 303 is released from the second portion 707, the continuous scroll operation stops.

In one embodiment, the first and second directions are substantially opposite directions, such as scrolling left and right around the radial sensor array 700, or up and down around the radial sensor array 750, or the like. Alternatively, the first and second directions are not substantially opposite directions.

In another embodiment, the presence of the conductive object 303 is detected at a first position on the radial sensor array 700, and the scrolling gesture, such as the continuous scroll-left gesture 754, is detected when the conductive object 303 is moved initially in a first direction (e.g., from a starting position on the right side of the first portion 706 of the radial sensor array 700 to the left) and subsequently in a second direction (e.g., to the right back towards the starting position). The end of the scrolling gesture is detected when the conductive object 303 is released from the radial sensor array 700. It should be noted that the conductive object 303 may be moved in multiple directions before the conductive object 303 is released, and so long as the conductive object 303 remains on the first portion 706 of the radial sensor array 700, the scrolling gesture continues to be detected by the processing device 210. In another embodiment, the continuous scroll-right gesture 755 can also be detected on the first portion 706 when the conductive object is moved initially to the right from a starting position on the left side of the first portion 706 of the radial sensor array 700. As such, both continuous scroll-left and scroll-right gestures 754 and 755 may be detected on the first portion 706 of the radial sensor array 700. Similarly, both continuous scroll-left and scroll-right gestures 754 and 755 may be detected on the second portion 707 of the radial sensor array 700. In another embodiment, both continuous scroll-up and scroll-down gestures 794 and 795 may be detected on either the first or second portions 706 or 707 of the radial sensor array 707. Alternatively, the continuous scroll-up and scroll-down gestures 794 and 795 may be detected on separate portions.

It should be noted that in the embodiments above, the end of the scrolling gesture is detected when the conductive object 303 is released from either the radial sensor array 700 or 750.

In another embodiment, the processing device 210 is configured to detect other types of scrolling-operations in other types of configurations, such as by defining the first and second portions 706 and 707 in different configurations, or by designating first and second zones on the radial sensor array 700 or 750, as described above with respect to FIGS. 6A and 6B.

It should also be noted that although the embodiments of FIGS. 7A-7C describe and illustrate detecting radial movements of the conductive object on the radial sensor arrays 700 and 750, in other embodiments, linear movements of the conductive object on the radial sensor array 700 and 750 to detect the various types of gestures, as described above. In one embodiment, the processing device is configured to detect both radial and linear movements and perform operations in response to the particular type of movement, for example, in response to detecting linear movement, the device may perform a first type of operation and, in response to detecting radial movement, the device may perform a second type of operation. Alternatively, the processing device may be configured to detect the both radial and linear movements, and in response, perform similar operations for the detected movements.

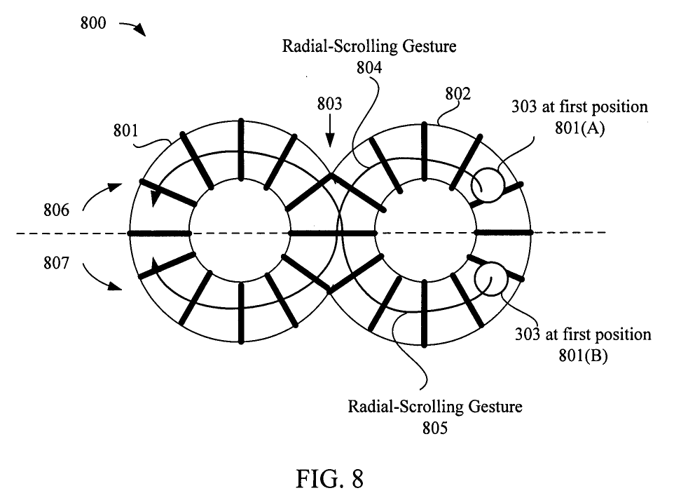

FIG. 8 illustrates a figure-eight-shaped radial slider 800 to detect radial-scrolling gestures and left- and right-scrolling gestures according to one embodiment of the present invention. The figure-eight-shaped radial slider 800 includes multiple sensor elements that are disposed in two rings 801 and 802 that have an overlapping section 803 between the two rings 801 and 802. The processing device 210 (not illustrated in FIG. 8) is configured to detect a presence of a conductive object 303 on the figure-eight-shaped radial slider array 800. The processing device 210 is also configured to detect position, movement, direction, and/or speed of the conductive object 303 on the figure-eight-shaped radial slider array 800, as describe above. The processing device 210 is configured to detect various types of scrolling gestures on the figure-eight-shaped radial slider array 800, similar to the gestures describe above.

In one embodiment, a first radial-scrolling gesture 804 is initiated when the conductive object 303 is detected as moving to the left of a first position 801(A) in the first portion 806 on the second ring 802. The first radial-scrolling gesture 804 continues to be detected as the conductive object 303 moves from the second ring 802 through the overlapping section 830 and into the second portion 807 of the first ring 801. Similarly, a second radial-scrolling gesture 805 is initiated when the conductive object 303 is detected as moving the left of a first position 801(B) in the second portion 807 on the second ring 802. The second radial-scrolling gesture 804 continues to be detected as the conductive object 303 moves from the second ring 802 through the overlapping section 803 and into the first portion 806 of the first ring. In one embodiment, the first radial-scrolling gesture 804 is a right-scrolling gesture, and the second radial-scrolling gesture 805 is a left-scrolling gesture. In another embodiment, the first radial-scrolling gesture 804 is a left-scrolling gesture, and the second radial-scrolling gesture 805 is a right-scrolling gesture. Alternatively, the first radial- and second radial-scrolling gestures 804 and 805 are other types of scrolling gestures, such as up- and down-scrolling gestures, or the like.

As described above, the scrolling operations, in the embodiments describe above, continue until the conductive object 303 is released from the figure-eight-shaped sensor array 800.

In another embodiment, the processing device 210 is configured to detect other types of scrolling-operations in other types of configurations, such as by defining the first and second portions 806 and 807 in different configurations, or by designating first and second zones on the figure-eight-shaped sensor array 800, as described above with respect to FIGS. 6A and 6B.

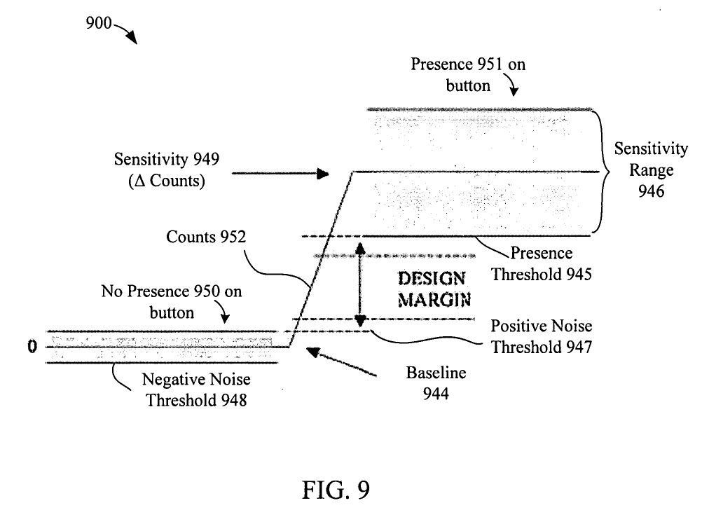

FIG. 9 illustrates a graph of a sensitivity of a single sensor element of a sensor array. Graph 900 includes the counts 952 as measured on a single sensor element for “No Presence” 950 on the sensor element, and for a “Presence” 951 on the sensor element. In one embodiment, when the “Presence” 951 is detected, a position of the conductive object 303 is determined. The “No Presence” 950 occurs when the user interface does not detect the presence of the conductive object 303. The “No Presence” 950 is detected between a range of noise. The range of noise may include a positive noise threshold 947 and a negative noise threshold 948. So long as the counts 952 are measured as being between the positive and negative thresholds 947 and 948, the user interface detects “No Presence” 950. The “Presence” 951 is when the user interface detects the presence of the conductive object 303 (e.g., finger). The “Presence” 951 is detected when the counts 952 are greater than a presence threshold 945. The presence threshold 945 indicates that a presence of a conductive object 303 is detected on the user interface during sensing the sensor elements. The sensitivity 949 of the single button operation is such that when it detects the presence of the conductive object 303, the capacitance variation (Δn), as represented by counts 952, is above the presence threshold 945. The sensitivity 949 may have a range, sensitivity range 946. Sensitivity range 946 may have a lower and upper limit or threshold. The lower threshold is equal to or greater than the presence threshold 945, allowing a “presence” 951 to be detected on or in proximity to the sensor element. The user interface may be configured such that there is a design margin between the presence threshold 945 and the positive noise threshold 947. The sensitivity range 946 is based on the surface area of the touch-sensor button, as well as other factors.

Although FIG. 9 is usually representative of the sensitivity of a single sensor element, FIG. 9 may also illustrate the sensitivity of a group of coupled sensor elements. It should also be noted that the values of parameters in the graph of FIG. 9 may be different for the different configurations. For example, in scanning a sensor element individually, the presence threshold 945 may be set to have an arbitrary count of 100 counts, based on factors such as scan speed, surface area, and the like. It should be noted in this embodiment, separate baseline measurement can be made for each of the sensor elements that are being measured individually, and the capacitance on a particular sensor element is compared against a presence threshold, such as the presence threshold 945, to determine if the particular sensor element has been activated. However, using the same hardware (e.g., sensor elements, ground conductors, capacitance sensing pins, processing device, and the like), in scanning the group of coupled sensor elements, the presence threshold may be set to have a similar or dissimilar presence threshold, for example, a lower count than the 100 counts used in the other configuration. Alternatively, other thresholds may be set for the different configurations.

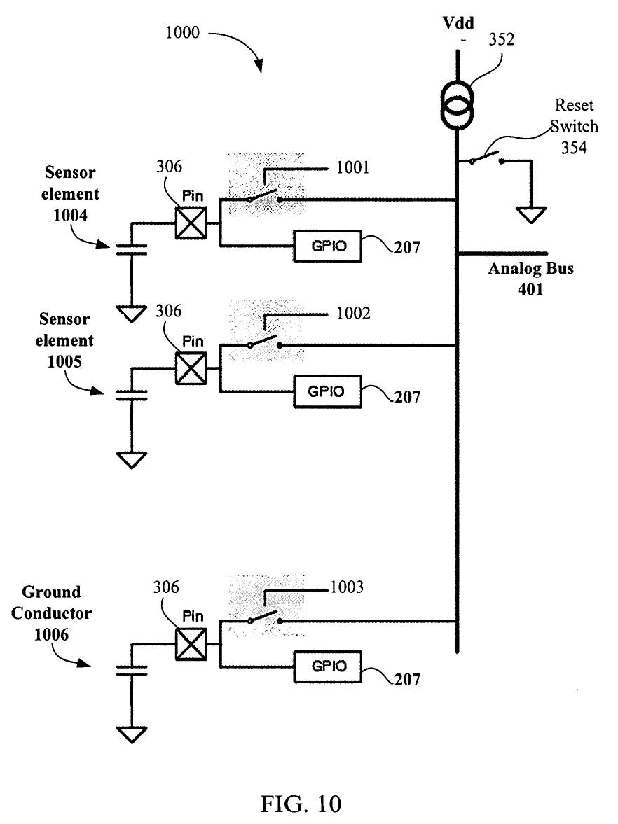

FIG. 10 illustrates one embodiment of a selection circuit 1000 coupled to an analog bus 401 for measuring capacitance on the sensor elements 1004 and 1005. The selection circuit 1000 is coupled to the sensor elements (e.g., 1004, 1005, and ground conductor 1006) via capacitance sensing pins 306, current source 352, reset switch 354, and a comparator 353 (not illustrated) via analog bus 401. The selection circuit 1000 may be configured to sequentially select a sensor element of the multiple sensor elements 1004 and 1005 to provide the charge current and to measure the capacitance of each sensor element 1004 and 1005, individually.

It should be noted that although the selection circuit 1000 is illustrated and described with respect to a relaxation oscillator having the current source 352, reset switch 354, and comparator 353, alternatively, the selection circuit 1000 is implemented with other types of circuits for measuring capacitance, such as the circuit 375 that includes the sigma-delta modulator 360, or other types of capacitance measuring circuits, such as current versus voltage phase shift measurement, resistor-capacitor charge timing, capacitive bridge divider, charge transfer, sigma-delta modulators, charge-accumulation circuits, or the like.

In one exemplary embodiment, the selection circuit 1000 is a multiplexer array of the relaxation oscillator 350 or circuit 375. Alternatively, selection circuit 1000 may be other circuitry outside the relaxation oscillator 350 or circuit 375, or even outside the capacitance sensor 201 to select the sensor element to be measured. The selection circuit 1000 may also be used to ground the sensor elements that are not being measured. This may be done in conjunction with a dedicated pin in the GPIO port 207. The selection circuit 1000 may also be used to couple all the sensor elements 1004 and 1005 at the same time. When the sensor elements 1004 and 1005 are coupled together the processing device 210 may be configured to measure the capacitance on the two sensor elements. Alternatively, the processing device 210 may sequentially or simultaneously scan each of the sensor elements individually. In one embodiment, when the sensor element 1004 is being scanned, the sensor element 1005 is coupled to ground. In another embodiment, the ground conductor 1006 is a ground plane that is disposed adjacent to or surrounding the sensor elements 1004 and 1005. The processing device 210 can select the sensor elements 1004 and 1005, as well as the ground conductor 1006, using selection control lines 1001, 1002, and 1003, respectively.

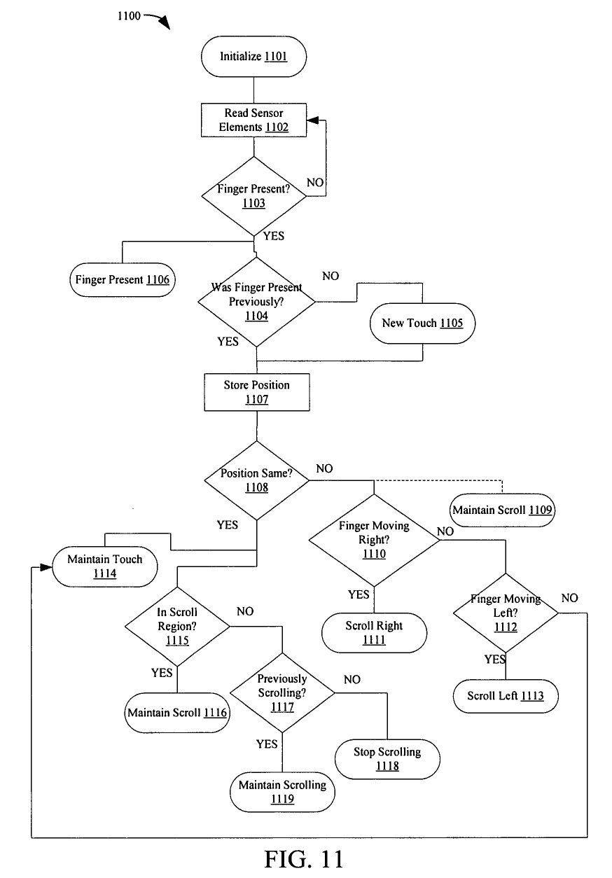

FIG. 11 illustrates a flow chart of one embodiment of a method 1100 for detecting various scrolling gestures on a sensor array. The method 1100 initializes an operation 1101, and reads the sensor elements of the sensory array, operation 1102. In operation 1103, the processing device 210 determines if a finger (e.g., conductive object 303) is present on the sensor array or not. If the finger is present, the processing device 210 may then send a signal or command having the finger present status to the host 250 to indicate that the finger is present, operation 1106. However, if the method detects that the finger is not present in operation 1103, the method 1100 returns to operation 1102 to read the sensor elements. When finger is present in operation 1103, the processing device 210 determines if the finger was present previously on the sensor array or not. If the finger was present previously, the processing device determines and stores the position of the finger, operation 1107. Similarly, the position determined in operation 1107 can also be sent to the host 250. However, if the processing device 210 determines that the finger was not previously present in operation 1104, the processing device 210 determines that a new touch has occurred, operation 1105, and determines and stores the position of the finger in operation 1107. The processing device 210 may then send a signal or command to the host 250 to indicate a new touch has occurred.

In operation 1108, the processing device 210 determines if the current position is the same as the previously determined position when previously present, if any. If the position is the same in operation 1108, the processing device 210 determines that the touch is maintained in operation 1114. However, if the position is not the same, the processing device 210 maintains the scroll, operation 1109. The processing device 210 also determines whether the finger is moving right or left. In particular, the method 1100 includes determining if the finger is moving right, operation 1110. If the finger is moving right in operation 1110, the processing device 210 detects a scroll right gesture, operation 1111. However, if the finger is not moving right in operation 1110, the processing device 210 determines if the finger is moving to the left, operation 1112. If the finger is moving to the left in operation 1112, the processing device 210 detects a scroll left gesture, operation 1113. However, if the finger is not moving to the left in operation 1112, the processing device 210 maintains the touch in operation 1114.

In addition to maintaining the touch in operation 1114, after determining that the position is the same in operation 1108, the processing device 210 determines if the position is in the scroll region (e.g., first zone 607 as described with respect to FIG. 6A). If the position is in the scroll region, the processing device 210 maintains the scroll 1116. If the finger is not in the scroll region, the processing device 210 determines if the conductive object 303 was previously detected as scrolling, operation 1117. If the conductive object 303 was previously detected as not scrolling in operation 1117, the scrolling is stopped, operation 1118. However, if the conductive object 303 was previously detected as scrolling in operation 1117, the processing device 210 maintains the scrolling, operation 1119.

In one embodiment, the processing device 210 uses the determined positions of the conductive object to output gestures based on the positions and the change in positions (e.g., movement of the conductive object). The processing device 210 may output a right-scrolling gesture (e.g., a long or short right-scrolling gesture) based on the conductive object 303 being moved to the right of a starting position, and a left-scrolling gesture (e.g., a long or short left-scrolling gesture) based on the conductive object 303 being moved to the left of a starting position. The processing device 210 may also detect right and left drag gestures. A drag gesture is when a button is being held and a scroll operation is performed. Alternatively, the processing device 210 may detect other types of gestures as known to those of ordinary skill in the art. Regardless of the gesture that is detected on the sensor array, the gesture is maintained so long as the sensor array remains active. The sensor array may remain active so long as the conductive object 303 remains in contact with, or in close proximity to the sensor array.

In another embodiment, a linear sensor array is configured to determine multiple presses and generates different gestures based on the presence of multiple inputs, in conjunction with the processing device 210. In another embodiment, a radial sensor array is configured to determine multiple presses and generates different gestures based on the presence of multiple inputs, in conjunction with the processing device 210.

In another embodiment, a radial slider is configured to determine the presence of a conductive object on the radial sensor array in conjunction with the processing device 210. The radial slider may have two or more portions (e.g., sensor elements on the left and right sides, or top and bottom sensor elements), and the processing device 210 is configured to perform different functions based on the position of the conductive object 303. For example, a first operation is performed in response to a first gesture being detected in a first portion of the radial sensor array, such as a left-scrolling gesture detected in the first portion, and a second operation is performed in response to a second gesture being detected in a second portion of the radial sensor array, such as a right-scrolling gesture detected in the second portion. The detected gesture is maintained so long as the conductive object 303 is not released from the respective portion of the radial sensor array. In another embodiment, in addition to the two operations performed, an additional operation may be performed in response to the conductive object 303 moving across the first and second portions, such as a radial-scrolling gesture, as described above.

In another embodiment, two linear sliders are configured to determine the presence of a conductive object on either of the linear sensor arrays in conjunction with the processing device 210. The processing device 210 is configured to perform different functions based on the position of the conductive object 303. For example, a first operation is performed in response to a first gesture being detected in a first linear sensor array, such as a left-scrolling gesture detected on the first linear sensor array, and a second operation is performed in response to a second gesture being detected in a second linear sensor array, such as a right-scrolling gesture detected on the second linear sensor array. The detected gesture is maintained so long as the conductive object 303 is not released from the respective linear sensor array. In another embodiment, in addition to the two operations performed, an additional operation may be performed in response to the conductive object 303 moving across the first and second linear sensor arrays, such as a radial-scrolling gesture, as described above.

In another embodiment, two linear sensor arrays perform similar gesture recognition as a single radial sensor array, such as described above with respect to FIGS. 5A-5C. In another embodiment, a single sensor array performs similar gesture recognition as a single radial sensor array, such as described above with respect to FIGS. 6A-6B.

In another embodiment, a scroll-right gesture is detected when the conductive object 303 is detected as moving to the right of the first position without the conductive object 303 being released from the sensor array, and a scroll-left gesture is detected when the conductive object 303 is detected as moving to the left of the first position without the conductive object 303 being released from the sensor array. In another embodiment, a scroll-up gesture is detected when the conductive object 303 is detected as moving upwards from the first position without the conductive object 303 being released from the sensor array, and a scroll-down gesture is detected when the conductive object 303 is detected as moving downwards from the first position without the conductive object 303 being released from the sensor array.

In another embodiment, a scroll-right-and-stop gesture is detected when the conductive object 303 is detected as moving to the right of the first position and the conductive object 303 is released from the sensor array at a second position that is to the left of a first zone of the sensor array, and a scroll-left-and-stop gesture is detected when the conductive object 303 is detected to the left of the first position and the conductive object 303 is released from the sensor array at a third position that is to the right of a second zone of the sensor array. In another embodiment, a scroll-up-and-stop gesture is detected when the conductive object 303 is detected as moving upwards from the first position and the conductive object 303 is released from the sensor array at a second position that is to below a first zone of the sensor array, and a scroll-down-and-stop gesture is detected when the conductive object 303 is detected down from the first position and the conductive object 303 is released from the sensor array at a third position that is above a second zone of the sensor array.

In another embodiment, a continuous scroll-right gesture is detected when the first position is detected in a first zone of the sensor array and when the conductive object 303 is detected as moving to the right of the first position and detected at a second position that is in a second zone of the sensor array without the conductive object 303 being released from the sensor array. The continuous scroll-right gesture is configured to stop when the conductive object 303 is released from the second zone. In another embodiment, a continuous scroll-left gesture is detected when the first position is detected in the second zone of the sensor array and when the conductive object 303 is detected as moving to the left of the first position and detected at a third position that is in the first zone of the sensor array without the conductive object 303 being released from the sensor array. The continuous scroll-left gesture is configured to stop when the conductive object 303 is released from the first zone.

There are several alternatives for construction of the sensor array of sensor elements. For example, the sensor elements may be pie or wedge shaped extending from the center point (e.g., tapered completely to the center). In an alternative embodiment, the sensor elements are fabricated in a ring configuration where the center of conductor on the movable plate is aligned with the outside of the sensor ring. The sensor elements may be pie or wedge shaped tapered partially to the center from the outer circumference of the sensor array. In another embodiment, the sensor elements are fabricated in a ring configuration where the center of the conductor on the movable plate is aligned with the inside of the sensor ring. The ring configuration may enable the addition of a separate center switch or button. The button may be a mechanical button, or alternatively, an additional sensor element may be disposed in the inner sensing area.

Embodiments of the present invention may have one or more of the following advantageous. The device, implementing the embodiments described herein, may be a smaller form-factor using the one or two linear sliders to detect radial scrolling gestures, instead of radial sliders as known to those of ordinary skill in the art. Another advantage may be that multiple output configurations may be used based on the information passed to the capacitive sensing controller. For example, the sensor array may be configured to operate as either a combined array or multiple separate arrays based on information passed from the host. In one mode, the two separate arrays may be configured to detect a scrolling operation for directional movements. In the second mode, the two separate arrays may be used as a single linear slider for normal slider operations. In other embodiments, the continuous scroll gesture can be accomplished without the conductive object being moved in at least one rotation of a radial sensor array, as done conventionally. For example, the continuous scroll gesture can be detected as the conductive object moves back and forth on a dedicated linear slider of a two linear slider design, back and forth on a single linear slider, or back and forth on a dedicated portion of a radial slider.

Embodiments of the present invention, described herein, include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method, comprising:
detecting a presence of a conductive object on a sensor array at a first position;
detecting a scrolling gesture on the sensor array when the conductive object is moved initially in a first direction from the first position and subsequently in a second direction; and
detecting an end of the scrolling gesture when the conductive object is released from the sensor array.

2. The method of claim 1, wherein detecting the scrolling gestures comprises:
detecting the conductive object in the first position;
detecting an initial motion of the conductive object in the first direction from the first position; and
detecting subsequent motion of the conductive object without the conductive object being released from the sensor array, wherein the subsequent motion includes at least one of up or down, or right or left motions of the conductive object on the sensor array.

3. The method of claim 2, further comprising:
detecting a first speed of the initial motion;
detecting a second speed of the subsequent motion; and
controlling a scrolling speed of the scrolling gesture based on the first speed and the second speed.

4. The method of claim 1, further comprising:
detecting a scroll-right gesture when the conductive object is detected as moving to the right of the first position without the conductive object being released from the sensor array; and
detecting a scroll-left gesture when the conductive object is detected to the left of the first position without the conductive object being released from the linear sensor array.

5. The method of claim 1, further comprising:
detecting a scroll-up gesture when the conductive object is detected as moving upwards from the first position without the conductive object being released from the sensor array; and
detecting a scroll-down gesture when the conductive object is detected as moving downwards from the first position without the conductive object being released from the linear sensor array.

6. The method of claim 1, further comprising:
detecting a scroll-right-and-stop gesture when the conductive object is detected as moving to the right of the first position and the conductive object is released from the sensor array at a second position that is to the right of the first position; and
detecting a scroll-left-and-stop gesture when the conductive object is detected to the left of the first position and the conductive object is released from the sensor array at a third position that is to the left of the first position.

7. The method of claim 1, further comprising:
detecting a scroll-up-and-stop gesture when the conductive object is detected as moving upwards from the first position and the conductive object is released from the sensor array at a second position that is above the first position of the sensor array;
detecting a scroll-down-and-stop gesture when the conductive object is detected moving downwards from the first position and the conductive object is released from the sensor array at a third position that is below the first position of the sensor array;

8. The method of claim 1, further comprising:
detecting a continuous scroll-right gesture when the first position is detected in a first zone of the sensor array and when the conductive object is detected as moving to the right of the first position and detected at a second position that is in a second zone of the sensor array without the conductive object being released from the sensor array, wherein the continuous scroll-right gesture is configured to stop scrolling when the conductive object is released from the second zone; and
detecting a continuous scroll-left gesture when the first position is detected in the second zone of the sensor array and when the conductive object is detected as moving to the left of the first position and detected at a third position that is in the first zone of the sensor array without the conductive object being released from the sensor array, wherein the continuous scroll-left gesture is configured to stop scrolling when the conductive object is released from the first zone.

9. The method of claim 1, further comprising:
detecting a continuous scroll-up gesture when the first position is detected in a first zone of the sensor array and when the conductive object is detected as moving upwards from the first position and detected at a second position that is in a second zone of the sensor array without the conductive object being released from the sensor array, wherein the continuous scroll-up gesture is configured to stop scrolling when the conductive object is released from the second zone; and
detecting a continuous scroll-down gesture when the first position is detected in the second zone of the sensor array and when the conductive object is detected as moving downwards from the first position and detected at a third position that is in the first zone of the sensor array without the conductive object being released from the sensor array, wherein the continuous scroll-down gesture is configured to stop scrolling when the conductive object is released from the first zone.

10. The method of claim 1, further comprising:
detecting a continuous scroll-right gesture when the conductive object is detected as initially moving to the right of the first position without the conductive object being released from the sensor array, wherein the continuous scroll-right gesture is configured to stop scrolling when the conductive object is released from sensor array; and
detecting a continuous scroll-left gesture when the conductive object is detected as initially moving to the left of the first position without the conductive object being released from the sensor array, wherein the continuous scroll-left gesture is configured to stop scrolling when the conductive object is released from the sensor array.

11. The method of claim 10, further comprising:
after the conductive object is initially moved to the right of the first position, subsequently detecting the conductive object moving to the left or right without the conductive object being released from the sensor array; and
after the conductive object is initially moved to the left of the first position, subsequently detecting the conductive object moving to the right or left without the conductive object being released from the sensor array.

12. The method of claim 1, further comprising:
detecting a continuous scroll-up gesture when the conductive object is detected as initially moving upwards from the first position without the conductive object being released from the sensor array, wherein the continuous scroll-up gesture is configured to stop scrolling when the conductive object is released from sensor array; and
detecting a continuous scroll-down gesture when the conductive object is detected as initially moving downwards from the first position without the conductive object being released from the sensor array, wherein the continuous scroll-down gesture is configured to stop scrolling when the conductive object is released from the sensor array.

13. The method of claim 12, further comprising:
after the conductive object is initially moved upwards the first position, subsequently detecting the conductive object moving downwards or upwards without the conductive object being released from the sensor array; and
after the conductive object is initially moved to the left of the first position, subsequently detecting the conductive object moving upwards or downwards without the conductive object being released from the sensor array.

14. An apparatus, comprising
a processing device coupled to receive signals from a first linear sensor array, wherein the processing device is configured to detect a continuous scrolling gesture on the first linear sensor array without a conductive object being released from and reapplied to the first linear sensor array to continue the continuous scrolling gesture.

15. The apparatus of claim 14, wherein the processing device is coupled to receive signals from a second linear sensor array, and wherein the processing device is configured to detect a second continuous scrolling gesture on the second linear sensor array without the conductive object being released from and reapplied to the second linear sensor array to continue the second continuous scrolling gesture.

16. The apparatus of claim 15, wherein the processing device is configured to detect a scroll-right gesture on the first linear sensor array and a scroll-left gesture on the second linear sensor array.

17. The apparatus of claim 14, wherein the processing device is configured to detect the conductive object in a first position on the first linear sensor array, an initial motion of the conductive object in a first direction from the first position, and subsequent motion of the conductive object on the first linear sensor array without the conductive object being released from the sensor array, and wherein the subsequent motion includes right or left motions of the conductive object on the first linear sensor array.

18. The apparatus of claim 15, wherein the processing device is configured to implement radial slider operations using the first and second linear sensor arrays.

19. An apparatus, comprising
a processing device coupled to receive signals from a radial sensor array, wherein the processing device is configured to detect a continuous scrolling gesture on the radial sensor array without a conductive object being moved in one or more rotations of the radial sensor array.

20. The apparatus of claim 19, wherein the processing device is configured to detect a scroll-right gesture on a first portion of the radial sensor array and a scroll-left gesture on a second portion of the radial sensor array.

21. The apparatus of claim 19, wherein the processing device is configured to detect the conductive object in a first position on the radial sensor array, an initial motion of the conductive object in a first direction from the first position, and subsequent motion of the conductive object on the radial sensor array without the conductive object being released from the sensor array and without the conductive object being moved in at least one rotation of the radial sensor array, and wherein the subsequent motion includes right or left motions of the conductive object on the first linear sensor array.

22. An apparatus, comprising:
means for detecting a scrolling gesture on a sensor array when a conductive object is moved initially in a first direction and subsequently in a second direction or the first direction; and
means for detecting an end of the scrolling gesture when the conductive object is released from the sensor array.

23. The apparatus of claim 15, wherein the means for detecting the scrolling gesture comprises means for detecting a continuous scrolling gesture on a sensor array without the conductive object being released from and reapplied to the sensor array and without the conductive object being moved in at least one rotation on the sensor array.
